(19) United States
(12) Patent Application Publication
(10) Pub. No.: US 2016/0309154 A1
(43) Pub. Date: Oct. 20, 2016

(54) DYNAMIC RANGE ADJUSTMENT FOR HIGH DYNAMIC RANGE AND WIDE COLOR GAMUT VIDEO CODING

(71) Applicant: QUALCOMM Incorporated, San Diego, CA (US)

(72) Inventors: Dmytro Rusanovskyy, San Diego, CA (US); Done Bugdayci Sansli, Tampere (FI); Joel Sole Rojals, San Diego, CA (US); Marta Karczewicz, San Diego, CA (US); Sungwon Lee, San Diego, CA (US); Adarsh Krishnan Ramasubramonian, San Diego, CA (US)

(21) Appl. No.: 15/099,256

(22) Filed: Apr. 14, 2016

Related U.S. Application Data
(60) Provisional application No. 62/149,446, filed on Apr. 17, 2015.

(51) Int. Cl. H04N 19/136; G06T 5/00; H04N 19/124; H04N 19/176; G06T 7/40; H04N 19/70

(52) U.S. Cl. CPC H04N 19/136; G06T 7/408; H04N 19/70; H04N 19/124; H04N 19/176; G06T 5/007; G06T 2207/20208

(57) ABSTRACT

This disclosure relates to processing video data, including processing video data to conform to a high dynamic range/wide color gamut (HDR/WCG) color container. As will be explained in more detail below, the techniques of the disclosure including dynamic range adjustment (DRA) parameters and apply the DRA parameters to video data in order to make better use of an HDR/WCG color container. The techniques of this disclosure may also include signaling syntax elements that allow a video decoder or video post processing device to reverse the DRA techniques of this disclosure to reconstruct the original or native color container of the video data.

This application claims the benefit of U.S. Provisional Application No. 62/149,446, filed Apr. 17, 2015, the entire content of which is incorporated by reference herein.

### TECHNICAL FIELD

This disclosure relates to video processing.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265, High Efficiency Video Coding (HEVC), and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy coding may be applied to achieve even more compression.

The total number of color values that may be captured, coded, and displayed may be defined by a color gamut. A color gamut refers to the range of colors that a device can capture (e.g., a camera) or reproduce (e.g., a display). Often, color gamuts differ from device to device. For video coding, a predefined color gamut for video data may be used such that each device in the video coding process may be configured to process pixel values in the same color gamut. Some color gamuts are defined with a larger range of colors than color gamuts that have been traditionally used for video coding. Such color gamuts with a larger range of colors may be referred to as a wide color gamut (WCG).

Another aspect of video data is dynamic range. Dynamic range is typically defined as the ratio between the minimum and maximum brightness (e.g., luminance) of a video signal. The dynamic range of common video data used in the past is considered to have a standard dynamic range (SDR). Other example specifications for video data define color data that has a larger ratio between the minimum and maximum brightness. Such video data may be described as having a high dynamic range (HDR).

### SUMMARY

This disclosure relates to processing video data, including processing video data to conform to an HDR/WCG color container. As will be explained in more detail below, the techniques of the disclosure apply dynamic range adjustment (DRA) parameters to video data in order to make better use of an HDR/WCG color container. The techniques of this disclosure may also include signaling syntax elements that allow a video decoder or video post processing device to reverse the DRA techniques of this disclosure to reconstruct the original or native color container of the video data.

In one example of the disclosure, a method of processing video data comprises receiving video data related to a first color container, the video data related to the first color container being defined by a first color gamut and a first color space, deriving one or more dynamic range adjustment parameters, the dynamic range adjustment parameters being based on characteristics of the video data as related to the first color container, and performing a dynamic range adjustment on the video data in accordance with the one or more dynamic range adjustment parameters.

In another example of the disclosure, an apparatus configured to process video data, the apparatus comprises a memory configured to store the video data, and one or more processors configured to receive the video data related to a first color container, the video data related to the first color container being defined by a first color gamut and a first color space, derive one or more dynamic range adjustment parameters, the dynamic range adjustment parameters being based on characteristics of the video data as related to the first color container, and perform a dynamic range adjustment on the video data in accordance with the one or more dynamic range adjustment parameters.

In another example of the disclosure, an apparatus configured to process video comprises means for receiving video data related to a first color container, the video data related to the first color container being defined by a first color gamut and a first color space, means for deriving one or more dynamic range adjustment parameters, the dynamic range adjustment parameters being based on characteristics of the video data as related to the first color container, and means for performing a dynamic range adjustment on the video data in accordance with the one or more dynamic range adjustment parameters.

In another example, this disclosure describes a computer-readable storage medium storing instructions that, when executed, cause one on more processors to receive the video data related to a first color container, the video data related to the first color container being defined by a first color gamut and a first color space, derive one or more dynamic range adjustment parameters, the dynamic range adjustment parameters being based on characteristics of the video data as related to the first color container and perform a dynamic range adjustment on the video data in accordance with the one or more dynamic range adjustment parameters.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system configured to implement the techniques of the disclosure.

FIG. 2 is a conceptual drawing illustrating the concepts of HDR data.

FIG. 3 is a conceptual diagram illustrating example color gamuts.

FIG. 4 is a flow diagram illustrating an example of HDR/WCG representation conversion.

FIG. 5 is a flow diagram illustrating an example of HDR/WCG inverse conversion.

FIG. 6 is conceptual diagram illustrating example of Electro-optical transfer functions (EOTF) utilized for video data conversion (including SDR and HDR) from perceptually uniform code levels to linear luminance.

FIGS. 7A and 7B are conceptual diagrams illustrating a visualization of color distribution in two example color gamuts.

FIG. 8 is a block diagram illustrating an example HDR/WCG conversion apparatus operating according to the techniques of this disclosure.

FIG. 9 is a block diagram illustrating an example HDR/WCG inverse conversion apparatus according to the techniques of this disclosure.

FIG. 10 is a block diagram illustrating an example of a video encoder that may implement techniques of this disclosure.

FIG. 11 is a block diagram illustrating an example of a video decoder that may implement techniques of this disclosure.

FIG. 12 is a flowchart illustrating an example HDR/WCG conversion process according to the techniques of this disclosure.

FIG. 13 is a flowchart illustrating an example HDR/WCG inverse conversion process according to the techniques of this disclosure.

### DETAILED DESCRIPTION

This disclosure is related to the processing and/or coding of video data with high dynamic range (HDR) and wide color gamut (WCG) representations. More specifically, the techniques of this disclosure include signaling and related operations applied to video data in certain color spaces to enable more efficient compression of HDR and WCG video data. The techniques and devices described herein may improve compression efficiency of hybrid-based video coding systems (e.g., H.265/HEVC, H.264/AVC, etc.) utilized for coding HDR and WCG video data.

Video coding standards, including hybrid-based video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions. The design of a new video coding standard, namely High Efficiency Video coding (HEVC, also called H.265), has been finalized by the Joint Collaboration Team on Video Coding (JCT-VC) of ITU-T Video Coding Experts Group (VCEG) and ISO/IEC Motion Picture Experts Group (MPEG). An HEVC draft specification referred to as HEVC Working Draft 10 (WD10), Bross et al., “High efficiency video coding (HEVC) text specification draft 10 (for FDIS & Last Call),” Joint Collaborative Team on Video Coding (JCT-VC) of ITU-T SG16 WP3 and ISO/IEC JTC1/SC29/WG11,12th Meeting: Geneva, CH, 14-23 January 2013, JCTVC-L1003v34, is available from http://phenix.int-evry.fr/jct/doc_end_user/documents/12Geneva/wg11/JCTVC-L1003 -v34. zip. The finalized HEVC standard is referred to as HEVC version 1.

A defect report, Wang et al., “High efficiency video coding (HEVC) Defect Report,” Joint Collaborative Team on Video Coding (JCT-VC) of ITU-T SG16 WP3 and ISO/IEC JTC1/SC29/WG11,14th Meeting: Vienna, AT, 25 July-2 August 2013, JCTVC-N1003v1, is available from http://phenix.int-evrv.fr/jct/doc_end_user/documents/14_Vienna/wg11/JCTVC-N1003-v1. zip. The finalized HEVC standard document is published as ITU-T H.265, Series H: Audiovisual and Multimedia Systems, Infrastructure of audiovisual services—Coding of moving video, High efficiency video coding, Telecommunication Standardization Sector of International Telecommunication Union (ITU), April 2013, and another version of the finalized HEVC standard was published in October 2014. A copy of the H.265/HEVC specification text may be downloaded from http://www.itu.int/rec/T-REC-H.265-201504-I/en.

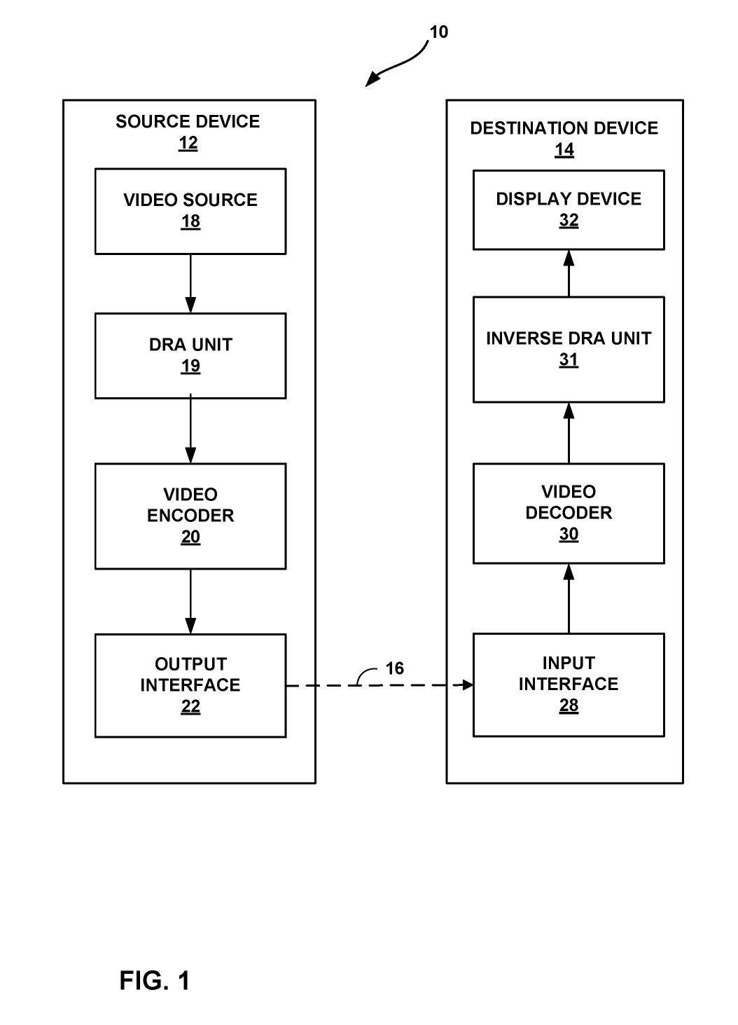

FIG. 1 is a block diagram illustrating an example video encoding and decoding system 10 that may utilize techniques of this disclosure. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming devices, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wired or wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In other examples, computer-readable medium 16 may include non-transitory storage media, such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, dynamic range adjustment (DRA) unit 19, video decoder 30, and display device 32. In accordance with this disclosure, DRA unit 19 of source device 12 may be configured to implement the techniques of this disclosure, including signaling and related operations applied to video data in certain color spaces to enable more efficient compression of HDR and WCG video data. In some examples, DRA unit 19 may be separate from video encoder 20. In other examples, DRA unit 19 may be part of video encoder 20. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for processing HDR and WCG video data may be performed by any digital video encoding and/or video decoding device. Moreover, the techniques of this disclosure may also be performed by a video preprocessor and/or video postprocessor. A video preprocessor may be any device configured to process video data before encoding (e.g., before HEVC encoding). A video postprocessor may be any device configured to process video data after decoding (e.g., after HEVC decoding). Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components, as well as a video preprocessor and a video postprocessor (e.g., DRA unit 19 and inverse DRA unit 31, respectively). Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding and video processing, in general, and may be applied to wireless and/or wired applications. In each case, the captured, pre-captured, or computer-generated video may be encoded by video encoder 20. The encoded video information may then be output by output interface 22 onto a computer-readable medium 16.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., groups of pictures (GOPs). Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

DRA unit 19 and inverse DRA unit 31 each may be implemented as any of a variety of suitable encoder circuitry, such as one or more microprocessors, DSPs, ASICs, FPGAs, discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure.

In some examples, video encoder 20 and video decoder 30 operate according to a video compression standard, such as ISO/IEC MPEG-4 Visual and ITU-T H.264 (also known as ISO/IEC MPEG-4 AVC), including its Scalable Video Coding (SVC) extension, Multi-view Video Coding (MVC) extension, and MVC-based three-dimensional video (3DV) extension. In some instances, any bitstream conforming to MVC-based 3DV always contains a sub-bitstream that is compliant to a MVC profile, e.g., stereo high profile. Furthermore, there is an ongoing effort to generate a 3DV coding extension to H.264/AVC, namely AVC-based 3DV. Other examples of video coding standards include ITU-T H.261, ISO/IEC MPEG-1 Visual, ITU-T H.262 or ISO/IEC MPEG-2 Visual, ITU-T H.263, ISO/IEC MPEG-4 Visual, and ITU-T H.264, ISO/IEC Visual. In other examples, video encoder 20 and video decoder 30 may be configured to operate according to the HEVC standard.

As will be explained in more detail below, DRA unit 19 and inverse DRA unit 31 may be configured to implement the techniques of this disclosure. In some examples, DRA unit 19 and/or inverse DRA unit 31 may be configured to receive video data related to an first color container, the first color container being defined by a first color gamut and a first color space, derive one or more dynamic range adjustment parameters, the dynamic range adjustment parameters being based on characteristics of the video data, and perform a dynamic range adjustment on the video data in accordance with the one or more dynamic range adjustment parameters.

DRA unit 19 and inverse DRA unit 31 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. As discussed above DRA unit 19 and inverse DRA unit 31 may be separate devices from video encoder 20 and video decoder 30, respectively. In other examples, DRA unit 19 may integrated with video encoder 20 in a single device and inverse DRA unit 31 may be integrated with video decoder 30 in a single device.

In HEVC and other video coding standards, a video sequence typically includes a series of pictures. Pictures may also be referred to as “frames.” A picture may include three sample arrays, denoted S_{L}, S_{Cb}, and S_{Cr}. S_{L} is a two-dimensional array (i.e., a block) of luma samples. S_{Cb} is a two-dimensional array of Cb chrominance samples. S_{Cr} is a two-dimensional array of Cr chrominance samples. Chrominance samples may also be referred to herein as “chroma” samples. In other instances, a picture may be monochrome and may only include an array of luma samples.

Video encoder 20 may generate a set of coding tree units (CTUs). Each of the CTUs may comprise a coding tree block of luma samples, two corresponding coding tree blocks of chroma samples, and syntax structures used to code the samples of the coding tree blocks. In a monochrome picture or a picture that has three separate color planes, a CTU may comprise a single coding tree block and syntax structures used to code the samples of the coding tree block. A coding tree block may be an NxN block of samples. A CTU may also be referred to as a “tree block” or a “largest coding unit” (LCU). The CTUs of HEVC may be broadly analogous to the macroblocks of other video coding standards, such as H.264/AVC. However, a CTU is not necessarily limited to a particular size and may include one or more coding units (CUs). A slice may include an integer number of CTUs ordered consecutively in the raster scan.

This disclosure may use the term “video unit” or “video block” to refer to one or more blocks of samples and syntax structures used to code samples of the one or more blocks of samples. Example types of video units may include CTUs, CUs, PUs, transform units (TUs) in HEVC, or macroblocks, macroblock partitions, and so on in other video coding standards.

To generate a coded CTU, video encoder 20 may recursively perform quad-tree partitioning on the coding tree blocks of a CTU to divide the coding tree blocks into coding blocks, hence the name “coding tree units.” A coding block is an NxN block of samples. A CU may comprise a coding block of luma samples and two corresponding coding blocks of chroma samples of a picture that has a luma sample array, a Cb sample array and a Cr sample array, and syntax structures used to code the samples of the coding blocks. In a monochrome picture or a picture that has three separate color planes, a CU may comprise a single coding block and syntax structures used to code the samples of the coding block.

Video encoder 20 may partition a coding block of a CU into one or more prediction blocks. A prediction block may be a rectangular (i.e., square or non-square) block of samples on which the same prediction is applied. A prediction unit (PU) of a CU may comprise a prediction block of luma samples, two corresponding prediction blocks of chroma samples of a picture, and syntax structures used to predict the prediction block samples. In a monochrome picture or a picture that have three separate color planes, a PU may comprise a single prediction block and syntax structures used to predict the prediction block samples. Video encoder 20 may generate predictive luma, Cb and Cr blocks for luma, Cb and Cr prediction blocks of each PU of the CU.

Video encoder 20 may use intra prediction or inter prediction to generate the predictive blocks for a PU. If video encoder 20 uses intra prediction to generate the predictive blocks of a PU, video encoder 20 may generate the predictive blocks of the PU based on decoded samples of the picture associated with the PU.

If video encoder 20 uses inter prediction to generate the predictive blocks of a PU, video encoder 20 may generate the predictive blocks of the PU based on decoded samples of one or more pictures other than the picture associated with the PU. Inter prediction may be uni-directional inter prediction (i.e., uni-prediction) or bi-directional inter prediction (i.e., bi-prediction). To perform uni-prediction or bi-prediction, video encoder 20 may generate a first reference picture list (RefPicList0) and a second reference picture list (RefPicList1) for a current slice.

Each of the reference picture lists may include one or more reference pictures. When using uni-prediction, video encoder 20 may search the reference pictures in either or both RefPicList0 and RefPicList1 to determine a reference location within a reference picture. Furthermore, when using uni-prediction, video encoder 20 may generate, based at least in part on samples corresponding to the reference location, the predictive sample blocks for the PU. Moreover, when using uni-prediction, video encoder 20 may generate a single motion vector that indicates a spatial displacement between a prediction block of the PU and the reference location. To indicate the spatial displacement between a prediction block of the PU and the reference location, a motion vector may include a horizontal component specifying a horizontal displacement between the prediction block of the PU and the reference location and may include a vertical component specifying a vertical displacement between the prediction block of the PU and the reference location.

When using bi-prediction to encode a PU, video encoder 20 may determine a first reference location in a reference picture in RefPicList0 and a second reference location in a reference picture in RefPicList1. Video encoder 20 may then generate, based at least in part on samples corresponding to the first and second reference locations, the predictive blocks for the PU. Moreover, when using bi-prediction to encode the PU, video encoder 20 may generate a first motion indicating a spatial displacement between a sample block of the PU and the first reference location and a second motion indicating a spatial displacement between the prediction block of the PU and the second reference location.

After video encoder 20 generates predictive luma, Cb, and Cr blocks for one or more PUs of a CU, video encoder 20 may generate a luma residual block for the CU. Each sample in the CU's luma residual block indicates a difference between a luma sample in one of the CU's predictive luma blocks and a corresponding sample in the CU's original luma coding block. In addition, video encoder 20 may generate a Cb residual block for the CU. Each sample in the CU's Cb residual block may indicate a difference between a Cb sample in one of the CU's predictive Cb blocks and a corresponding sample in the CU's original Cb coding block. Video encoder 20 may also generate a Cr residual block for the CU. Each sample in the CU's Cr residual block may indicate a difference between a Cr sample in one of the CU's predictive Cr blocks and a corresponding sample in the CU's original Cr coding block.

Furthermore, video encoder 20 may use quad-tree partitioning to decompose the luma, Cb and, Cr residual blocks of a CU into one or more luma, Cb, and Cr transform blocks. A transform block may be a rectangular block of samples on which the same transform is applied. A transform unit (TU) of a CU may comprise a transform block of luma samples, two corresponding transform blocks of chroma samples, and syntax structures used to transform the transform block samples. In a monochrome picture or a picture that has three separate color planes, a TU may comprise a single transform block and syntax structures used to transform the transform block samples. Thus, each TU of a CU may be associated with a luma transform block, a Cb transform block, and a Cr transform block. The luma transform block associated with the TU may be a sub-block of the CU's luma residual block. The Cb transform block may be a sub-block of the CU's Cb residual block. The Cr transform block may be a sub-block of the CU's Cr residual block.

Video encoder 20 may apply one or more transforms to a luma transform block of a TU to generate a luma coefficient block for the TU. A coefficient block may be a two-dimensional array of transform coefficients. A transform coefficient may be a scalar quantity. Video encoder 20 may apply one or more transforms to a Cb transform block of a TU to generate a Cb coefficient block for the TU. Video encoder 20 may apply one or more transforms to a Cr transform block of a TU to generate a Cr coefficient block for the TU.

After generating a coefficient block (e.g., a luma coefficient block, a Cb coefficient block or a Cr coefficient block), video encoder 20 may quantize the coefficient block. Quantization generally refers to a process in which transform coefficients are quantized to possibly reduce the amount of data used to represent the transform coefficients, providing further compression. Furthermore, video encoder 20 may inverse quantize transform coefficients and apply an inverse transform to the transform coefficients in order to reconstruct transform blocks of TUs of CUs of a picture. Video encoder 20 may use the reconstructed transform blocks of TUs of a CU and the predictive blocks of PUs of the CU to reconstruct coding blocks of the CU. By reconstructing the coding blocks of each CU of a picture, video encoder 20 may reconstruct the picture. Video encoder 20 may store reconstructed pictures in a decoded picture buffer (DPB). Video encoder 20 may use reconstructed pictures in the DPB for inter prediction and intra prediction.

After video encoder 20 quantizes a coefficient block, video encoder 20 may entropy encode syntax elements that indicate the quantized transform coefficients. For example, video encoder 20 may perform Context-Adaptive Binary Arithmetic Coding (CABAC) on the syntax elements indicating the quantized transform coefficients. Video encoder 20 may output the entropy-encoded syntax elements in a bitstream.

Video encoder 20 may output a bitstream that includes a sequence of bits that forms a representation of coded pictures and associated data. The bitstream may comprise a sequence of network abstraction layer (NAL) units. Each of the NAL units includes a NAL unit header and encapsulates a raw byte sequence payload (RBSP). The NAL unit header may include a syntax element that indicates a NAL unit type code. The NAL unit type code specified by the NAL unit header of a NAL unit indicates the type of the NAL unit. A RBSP may be a syntax structure containing an integer number of bytes that is encapsulated within a NAL unit. In some instances, an RBSP includes zero bits.

Different types of NAL units may encapsulate different types of RBSPs. For example, a first type of NAL unit may encapsulate a RBSP for a picture parameter set (PPS), a second type of NAL unit may encapsulate a RBSP for a coded slice, a third type of NAL unit may encapsulate a RBSP for Supplemental Enhancement Information (SEI), and so on. A PPS is a syntax structure that may contain syntax elements that apply to zero or more entire coded pictures. NAL units that encapsulate RBSPs for video coding data (as opposed to RBSPs for parameter sets and SEI messages) may be referred to as video coding layer (VCL) NAL units. A NAL unit that encapsulates a coded slice may be referred to herein as a coded slice NAL unit. A RB SP for a coded slice may include a slice header and slice data.

Video decoder 30 may receive a bitstream. In addition, video decoder 30 may parse the bitstream to decode syntax elements from the bitstream. Video decoder 30 may reconstruct the pictures of the video data based at least in part on the syntax elements decoded from the bitstream. The process to reconstruct the video data may be generally reciprocal to the process performed by video encoder 20. For instance, video decoder 30 may use motion vectors of PUs to determine predictive blocks for the PUs of a current CU. Video decoder 30 may use a motion vector or motion vectors of PUs to generate predictive blocks for the PUs.

In addition, video decoder 30 may inverse quantize coefficient blocks associated with TUs of the current CU. Video decoder 30 may perform inverse transforms on the coefficient blocks to reconstruct transform blocks associated with the TUs of the current CU. Video decoder 30 may reconstruct the coding blocks of the current CU by adding the samples of the predictive sample blocks for PUs of the current CU to corresponding samples of the transform blocks of the TUs of the current CU. By reconstructing the coding blocks for each CU of a picture, video decoder 30 may reconstruct the picture. Video decoder 30 may store decoded pictures in a decoded picture buffer for output and/or for use in decoding other pictures.

Next generation video applications are anticipated to operate with video data representing captured scenery with HDR and a WCG. Parameters of the utilized dynamic range and color gamut are two independent attributes of video content, and their specification for purposes of digital television and multimedia services are defined by several international standards. For example ITU-R Rec. BT.709, “Parameter values for the HDTV standards for production and international programme exchange,” defines parameters for HDTV (high definition television), such as standard dynamic range (SDR) and standard color gamut, and ITU-R Rec. BT.2020, “Parameter values for ultra-high definition television systems for production and international programme exchange,” specifies UHDTV (ultra-high definition television) parameters such as HDR and WCG. There are also other standards developing organization (SDOs) documents that specify dynamic range and color gamut attributes in other systems, e.g., DCI-P3 color gamut is defined in SMPTE-231-2 (Society of Motion Picture and Television Engineers) and some parameters of HDR are defined in SMPTE-2084. A brief description of dynamic range and color gamut for video data is provided below.

Dynamic range is typically defined as the ratio between the minimum and maximum brightness (e.g., luminance) of the video signal. Dynamic range may also be measured in terms of ‘f-stop,’ where one f-stop corresponds to a doubling of a signal's dynamic range. In MPEG's definition, HDR content is content that features brightness variation with more than 16 f-stops. In some terms, levels between 10 and 16 f-stops are considered as intermediate dynamic range, but it is considered HDR in other definitions. In some examples of this disclosure, HDR video content may be any video content that has a higher dynamic range than traditionally used video content with a standard dynamic range (e.g., video content as specified by ITU-R Rec. BT.709).

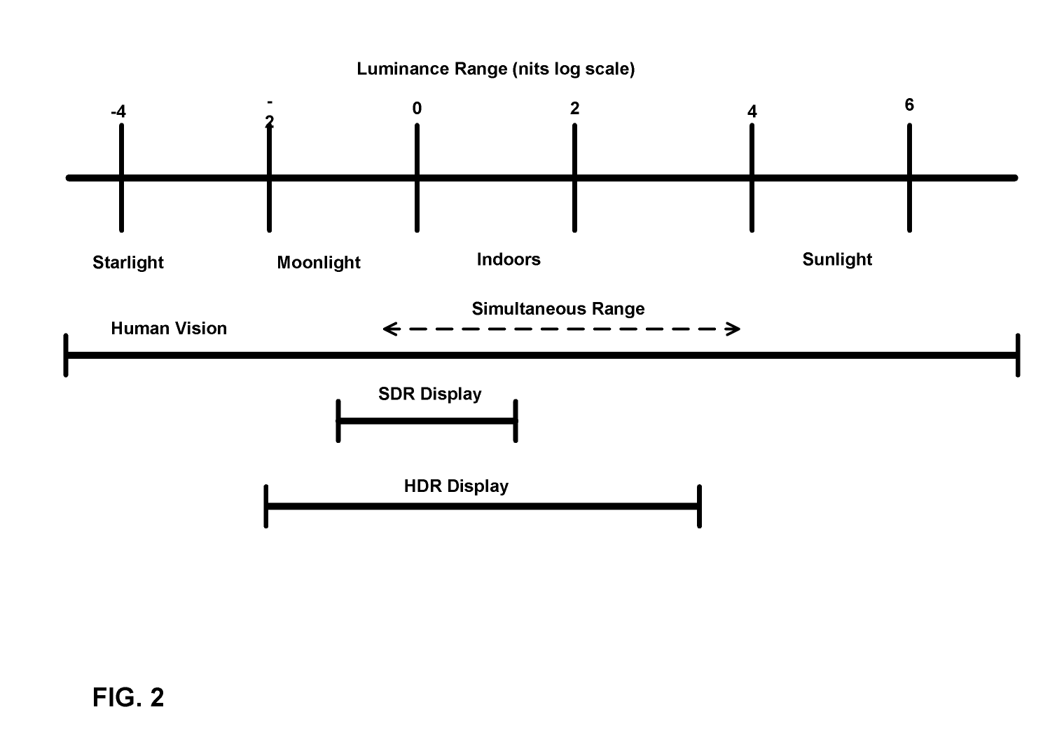

The human visual system (HVS) is capable for perceiving much larger dynamic ranges than SDR content and HDR content. However, the HVS includes an adaptation mechanism to narrow the dynamic range of the HVS to a so-called simultaneous range. The width of the simultaneous range may be dependent on current lighting conditions (e.g., current brightness). Visualization of dynamic range provided by SDR of HDTV, expected HDR of UHDTV and HVS dynamic range is shown in FIG. 2.

Current video application and services are regulated by ITU Rec.709 and provide SDR, typically supporting a range of brightness (e.g., luminance) of around 0.1 to 100 candelas (cd) per m2 (often referred to as “nits”), leading to less than 10 f-stops. Some example next generation video services are expected to provide dynamic range of up to 16 f-stops. Although detailed specifications for such content are currently under development, some initial parameters have been specified in SMPTE-2084 and ITU-R Rec. 2020.

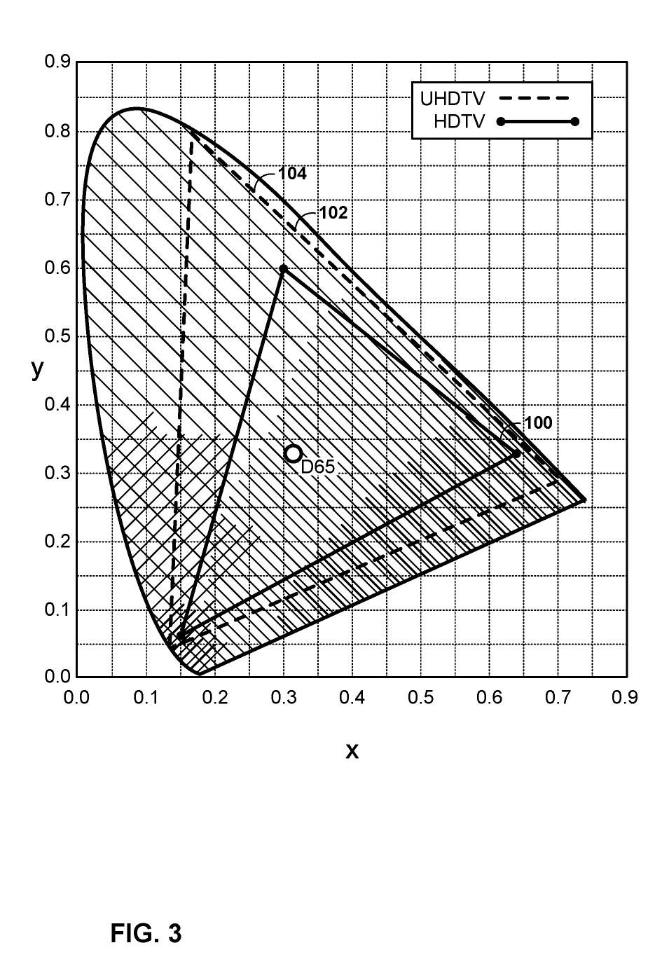

Another aspect for a more realistic video experience, besides HDR, is the color dimension. Color dimension is typically defined by the color gamut. FIG. 3 is a conceptual diagram showing an SDR color gamut (triangle 100 based on the BT.709 color primaries), and the wider color gamut that for UHDTV (triangle 102 based on the BT.2020 color primaries). FIG. 3 also depicts the so-called spectrum locus (delimited by the tongue-shaped area 104), representing the limits of the natural colors. As illustrated by FIG. 3, moving from BT.709 (triangle 100) to BT.2020 (triangle 102) color primaries aims to provide UHDTV services with about 70% more colors. D65 specifies an example white color for the BT.709 and/or BT.2020 specifications.

Examples of color gamut specifications for the DCI-P3, BT.709, and BT.202 color spaces are shown in Table 1.

TABLE 1
Color gamut parameters
RGB color space parameters

| Color | White point | | Primary colors | | | | | |
|---|---|---|---|---|---|---|---|---|
| space | x_{W} | y_{W} | x_{R} | y_{R} | x_{G} | y_{G} | x_{B} | y_{B} |
| DCI-P3 | 0.314 | 0.351 | 0.680 | 0.320 | 0.265 | 0.690 | 0.150 | 0.060 |
| ITU-R | 0.3127 | 0.3290 | 0.64 | 0.33 | 0.30 | 0.60 | 0.15 | 0.06 |
| BT.709 | | | | | | | | |
| ITU-R | 0.3127 | 0.3290 | 0.708 | 0.292 | 0.170 | 0.797 | 0.131 | 0.046 |
| BT.2020 | | | | | | | | |

As can be seen in Table 1, a color gamut may be defined by the X and Y values of a white point, and by the X and Y values of the primary colors (e.g., red (R), green (G), and blue (B). The X and Y values represent the chromaticity (X) and the brightness (Y) of the colors, as is defined by the CIE 1931 color space. The CIE 1931 color space defines the links between pure colors (e.g., in terms of wavelengths) and how the human eye perceives such colors.

HDR/WCG video data is typically acquired and stored at a very high precision per component (even floating point), with the 4:4:4 chroma sub-sampling format and a very wide color space (e.g., CIE XYZ). This representation targets high precision and is almost mathematically lossless. However, such a format for storing HDR/WCG video data may include a lot of redundancies and may not be optimal for compression purposes. A lower precision format with HVS-based assumptions is typically utilized for state-of-the-art video applications.

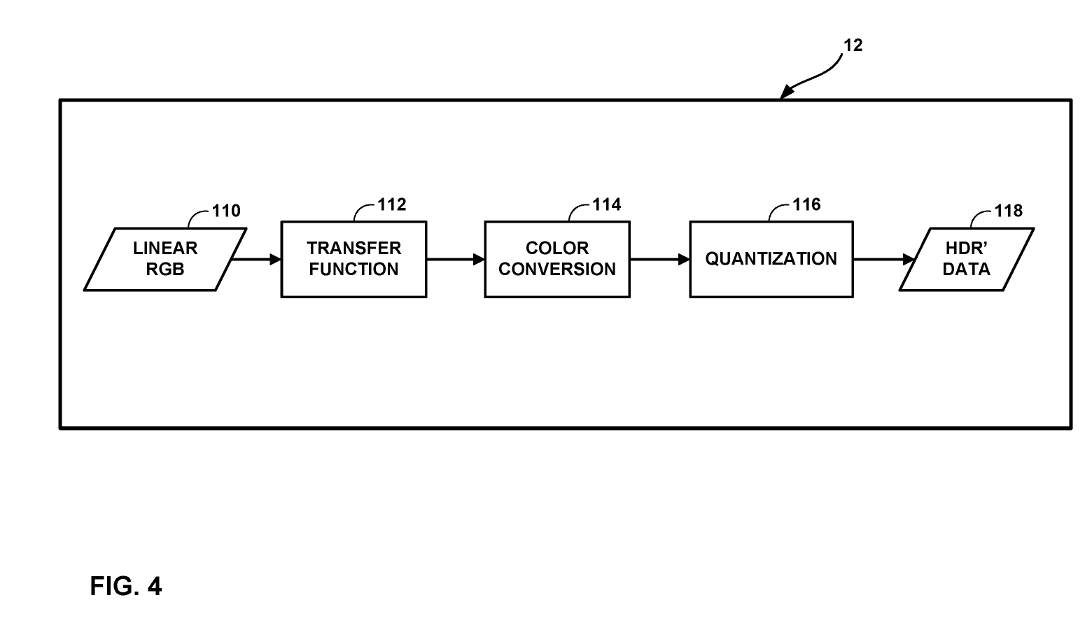

One example of a video data format conversion process for purposes of compression includes three major processes, as shown in FIG. 4. The techniques of FIG. 4 may be performed by source device 12. Linear RGB data 110 may be HDR/WCG video data and may be sored in a floating point representation. Linear RGB data 110 may be compacted using a non-linear transfer function (TF) 112 for dynamic range compacting. Transfer function 112 may compact linear RGB data 110 using any number of non-linear transfer functions, e.g., the PQ TF as defined in SMPTE-2084. In some examples, color conversion process 114 converts the compacted data into a more compact or robust color space (e.g., a YUV or YCrCb color space) that is more suitable for compression by a hybrid video encoder. This data is then quantized using a floating-to-integer representation quantization unit 116 to produce converted HDR′ data 118. In this example HDR′ data 118 is in an integer representation. The HDR′ data is now in a format more suitable for compression by a hybrid video encoder (e.g., video encoder 20 applying HEVC techniques). The order of the processes depicted in FIG. 4 is given as an example, and may vary in other applications. For example, color conversion may precede the TF process. In addition, additional processing, e.g. spatial subsampling, may be applied to color components.

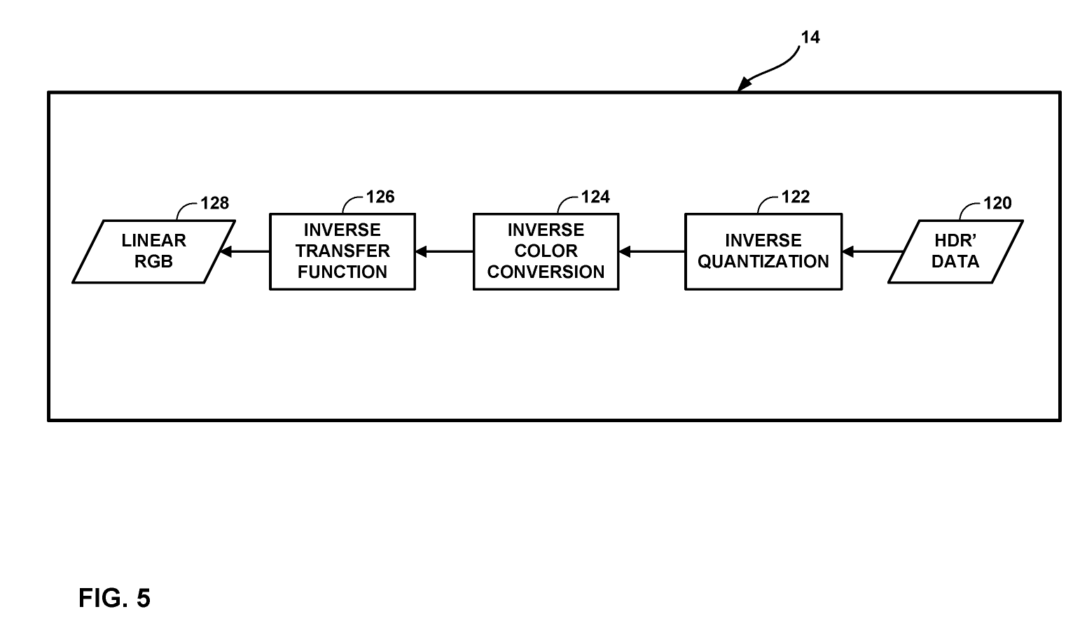

The inverse conversion at the decoder side is depicted in FIG. 5. The techniques of FIG. 5 may be performed by destination device 14. Converted HDR′ data 120 may be obtained at destination device 14 through decoding video data using a hybrid video decoder (e.g., video decoder 30 applying HEVC techniques). HDR′ data 120 may then be inverse quantized by inverse quantization unit 122. Then an inverse color conversion process 124 may be applied to the inverse quantized HDR′ data. The inverse color conversion process 124 may be the inverse of color conversion process 114. For example, the inverse color conversion process 124 may convert the HDR′ data from a YCrCb format back to an RGB format. Next, inverse transfer function 126 may be applied to the data to add back the dynamic range that was compacted by transfer function 112 to recreate the linear RGB data 128.

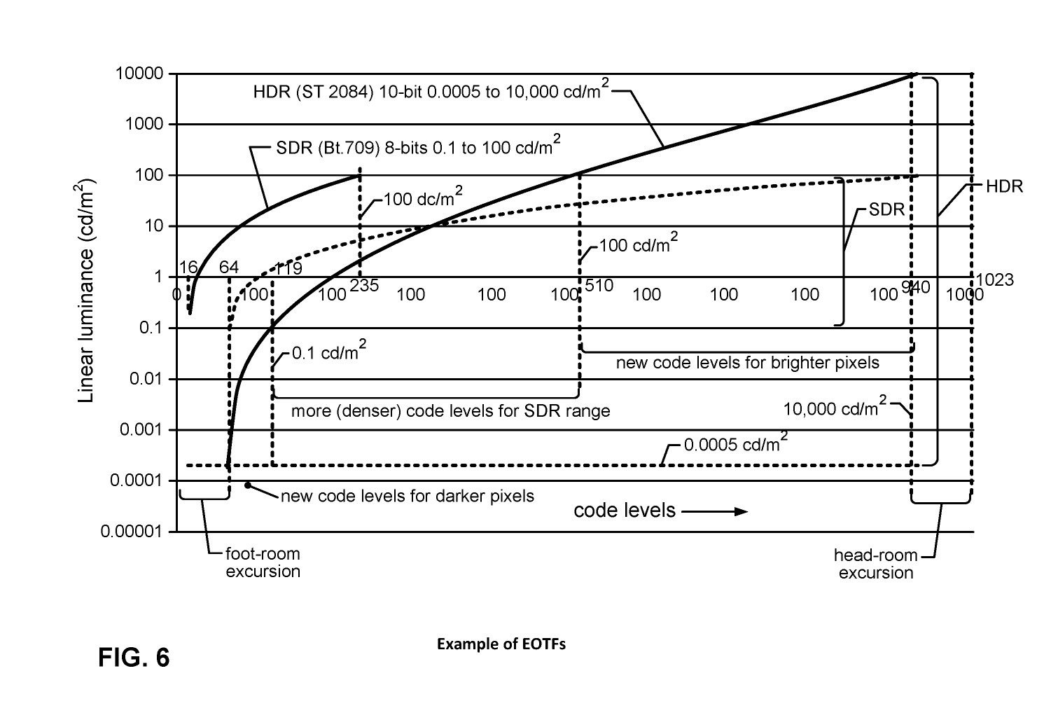

The techniques depicted in FIG. 4 will now be discussed in more detail. In general a transfer function is applied to data (e.g., HDR/WCG video data) to compact the dynamic range of the data. Such compaction allows the data to be represented with fewer bits. In one example, the transfer function may be a one-dimensional (1D) non-linear function and may reflect the inverse of an electro-optical transfer function (EOTF) of the end-user display, e.g., as specified for SDR in Rec. 709. In another example, the transfer function may approximate the HVS perception to brightness changes, e.g., the PQ transfer function specified in SMPTE-2084 for HDR. The inverse process of the OETF is the EOTF (electro-optical transfer function), which maps the code levels back to luminance. FIG. 6 shows several examples of non-linear transfer function used to compact the dynamic range of certain color containers. The transfer functions may also be applied to each R, G and B component separately.

In the context of this disclosure, the terms “signal value” or “color value” may be used to describe a luminance level corresponding to the value of a specific color component (such as R, G, B, or Y) for an image element. The signal value is typically representative of a linear light level (luminance value). The terms “code level” or “digital code value” may refer to a digital representation of an image signal value. Typically, such a digital representation is representative of a nonlinear signal value. An EOTF represents the relationship between the nonlinear signal values provided to a display device (e.g., display device 32) and the linear color values produced by the display device.

RGB data is typically utilized as the input color space, since RGB is the type of data that is typically produced by image capturing sensors. However, the RGB color space has high redundancy among its components and is not optimal for compact representation. To achieve more compact and a more robust representation, RGB components are typically converted (e.g., a color transform is performed) to a more uncorrelated color space that is more suitable for compression, e.g., YCbCr. A YCbCr color space separates the brightness in the form of luminance (Y) and color information (CrCb) in different less correlated components. In this context, a robust representation may refer to a color space featuring higher levels of error resilience when compressed at a constrained bitrate.

Following the color transform, input data in a target color space may be still represented at high bit-depth (e.g. floating point accuracy). The high bit-depth data may be converted to a target bit-depth, for example, using a quantization process. Certain studies show that 10-12 bits accuracy in combination with the PQ transfer is sufficient to provide HDR data of 16 f-stops with distortion below the Just-Noticeable Difference (JND). In general, a JND is the amount something (e.g., video data) must be change in order for a difference to be noticeable (e.g., by the HVS). Data represented with 10 bits accuracy can be further coded with most of the state-of-the-art video coding solutions. This quantization is an element of lossy coding and is a source of inaccuracy introduced to converted data.

It is anticipated that next generation HDR/WCG video applications will operate with video data captured at different parameters of HDR and CG. Examples of different configuration can be the capture of HDR video content with peak brightness up-to 1000 nits, or up-to 10,000 nits. Examples of different color gamut may include BT.709, BT.2020 as well SMPTE specified-P3, or others.

It is also anticipated that a single color space, e.g., a target color container, that incorporates all other currently used color gamut to be utilized in future. One example of such a target color container is BT.2020. Support of a single target color container would significantly simplify standardization, implementation and deployment of HDR/WCG systems, since a reduced number of operational points (e.g., number of color containers, color spaces, color conversion algorithms, etc.) and/or a reduced number of required algorithms should be supported by a decoder (e.g., video decoder 30).

In one example of such a system, content captured with a native color gamut (e.g. P3 or BT.709) different from the target color container (e.g. BT.2020) may be converted to the target container prior to processing (e.g., prior to video encoding). Below are several examples of such conversion:

RGB conversion from BT.709 to BT.2020 color container:

R₂₀₂₀=0.627404078626*R₇₀₉+0.329282097415*G₇₀₉+0.043313797587*B₇₀₉

G₂₀₂₀=0.069097233123*R₇₀₉+0.919541035593*G₇₀₉+0.011361189924*B₇₀₉

B₂₀₂₀=0.016391587664*R₇₀₉+0.088013255546*G₇₀₉+0.895595009604*B₇₀₉ (1)

RGB conversion from P3 to BT.2020 color container:

R₂₀₂₀=0.753832826496*R_{P3}+0.198597635641*G_{P3}+0.047569409186*B_{P3}

G₂₀₂₀=0.045744636411*R_{P3}+0.941777687331*G_{P3}+0.012478735611*B_{P3}

B₂₀₂₀=−0.001210377285*R_{P3}+0.017601107390*G_{P3}+0.983608137835*B_{P3} (2)

During this conversion, the dynamic range of a signal captured in P3 or BT.709 color gamut may be reduced in a BT.2020 representation. Since the data is represented in floating point accuracy, there is no loss; however, when combined with color conversion (e.g., a conversion from RGB to YCrCB shown in equation 3 below) and quantization (example in equation 4 below), dynamic range reduction leads to increased quantization error for input data.

$$\begin{matrix}{Y}^{′} = 0.2627 * {R}^{′} + 0.6780 * {G}^{′} + 0.0593 * {B}^{′} ; \\ Cb = \frac{{B}^{′} - {Y}^{′}}{1.8814} ; \\ Cr = \frac{{R}^{′} - {Y}^{′}}{1.4746} & ( 3 ) \\ {D}_{{Y}^{′}} = ( Round ( ( 1 << ( {BitDepth}_{Y} - 8 ) ) * ( 219 * {Y}^{′} + 16 ) ) ) \\ {D}_{Cb} = ( Round ( ( 1 << ( {BitDepth}_{Cr} - 8 ) ) * ( 224 * Cb + 128 ) ) ) \\ {D}_{Cr} = ( Round ( ( 1 << ( {BitDepth}_{Cb} - 8 ) ) * ( 224 * Cr + 128 ) ) ) & ( 4 )\end{matrix}$$

In equation (4) D_{Y′} is the quantized Y′ component, D_{Cb} is the quantized Cb and D_{Cr} is the quantized Cr component. The term <<represents a bit-wise right shift. BitDepth_{Y}, BitDepth_{Cr}, and BitDepth_{Cb} are the desired bit depths of the quantized components, respectively.

In addition, in a real-world coding system, coding a signal with reduced dynamic range may lead to significant loss of accuracy for coded chroma components and would be observed by a viewer as coding artifacts, e.g., color mismatch and/or color bleeding.

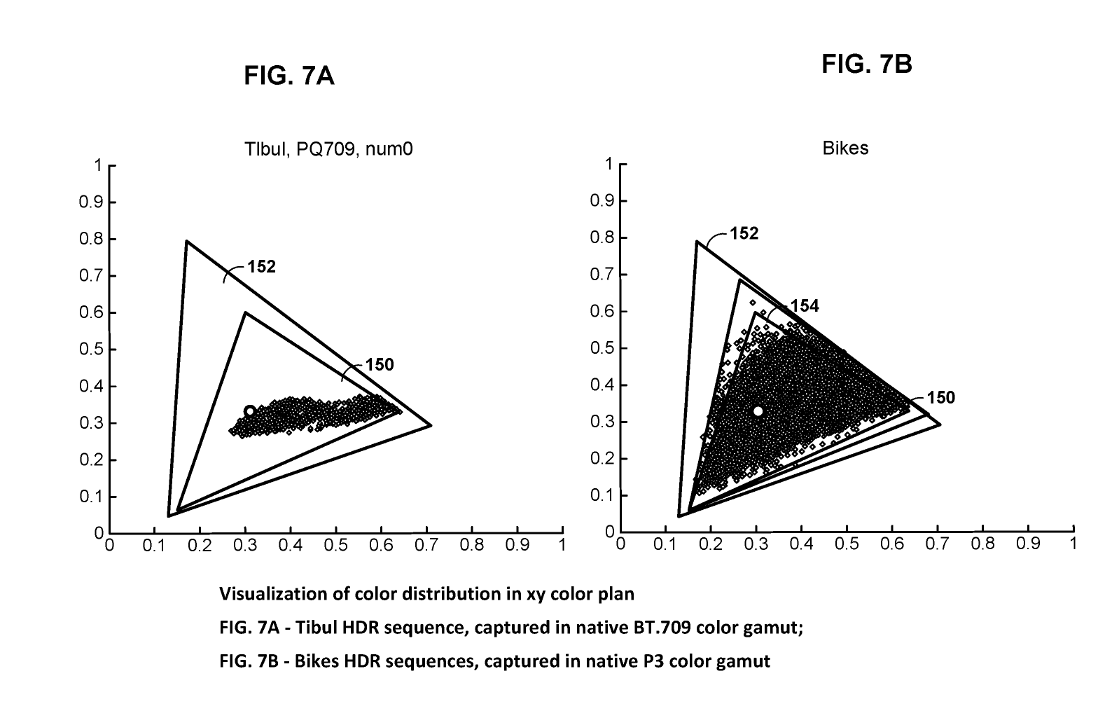

An issue may also arise when the color gamut of the content is the same as the color gamut of the target color container, but the content does not fully occupy the gamut of the entire color container (e.g., in some frames or for one component). This situation is visualized in FIG. 7A and 7B, where colors of HDR sequences are depicted in an xy color plane. FIG. 7A shows colors of a “Tibul” test sequence captured in native BT.709 color space (triangle 150). However, the colors of the test sequence (shown as dots) do not occupy the full color gamut of BT.709. In FIG. 7A and 7B, triangle 152 represents a BT. 2020 color gamut. FIG. 7B shows colors of a “Bikes” HDR test sequence with a P3 native color gamut (triangle 154). As can be seen in FIG. 7B, the colors do not occupy the full range of the native color gamut (triangle 154) in the xy color plane.

To address the problems described above, the following techniques may be considered. One example technique involves HDR coding at the native color space. In such a technique an HDR video coding system would support various types of currently known color gamuts, and allow extensions of a video coding standard to support future color gamuts. This support would not be only limited to support different color conversion transforms, e.g. RGB to YCbCr, and their inverse transforms, but also would specify transform functions that are adjusted to each of the color gamuts. Support of such variety of tools would complex and expensive.

Another example technique includes a color gamut aware video codec. In such a technique, a hypothetical video encoder is configured to estimate the native color gamut of the input signal and adjust coding parameters (e.g., quantization parameters for coded chroma components) to reduce any distortion resulting from the reduced dynamic range. However, such a technique would not be able to recover loss of accuracy, which may happen due to the quantization conducted in equation (4) above, since all input data is provided to a typical codec in integer point accuracy.

In view of the foregoing, this disclosure proposes techniques, methods, and apparatuses to perform a dynamic range adjustment (DRA) to compensate dynamic range changes introduced to HDR signal representations by a color gamut conversion. The dynamic range adjustment may help to prevent and/or lessen any distortion caused by a color gamut conversion, including color mismatch, color bleeding, etc. In one or more examples of the disclosure, DRA is conducted on the values of each color component of the target color space, e.g., YCbCr, prior to quantization at the encoder side (e.g., by source device 12) and after the inverse quantization at the decoder side (e.g., by destination device 14).

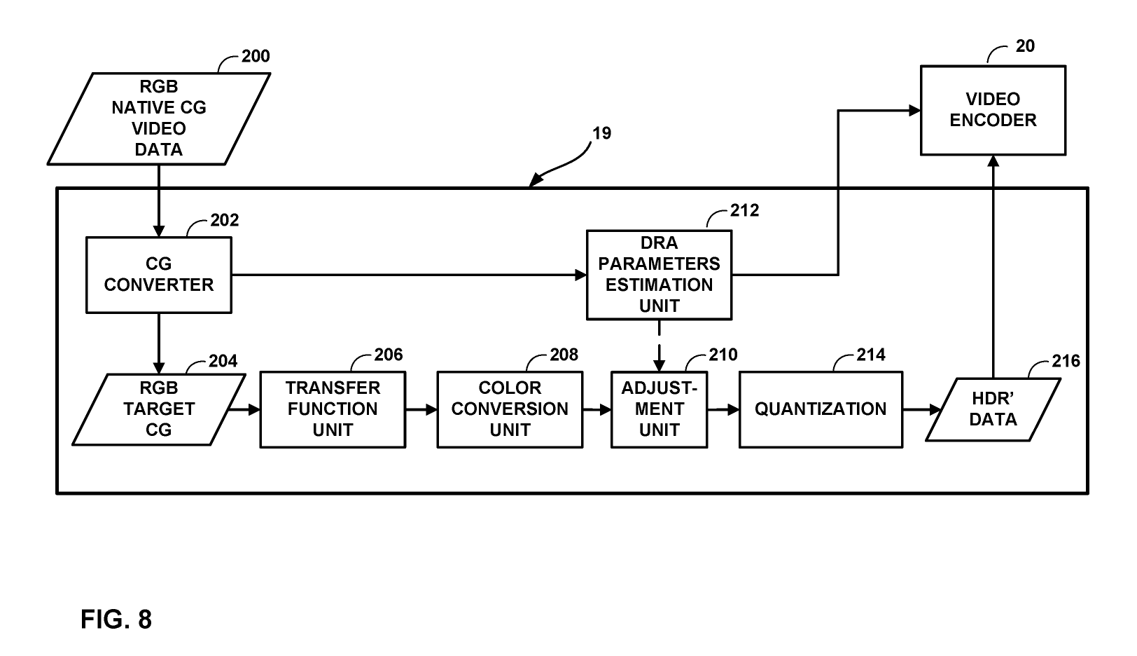

FIG. 8 is a block diagram illustrating an example HDR/WCG conversion apparatus operating according to the techniques of this disclosure. In FIG. 8, solid lines specify the data flow and dashed lines specify control signals. The techniques of this disclosure may be performed by DRA unit 19 of source device 12. As discussed above, DRA unit 19 may be a separate device from video encoder 20. In other examples, DRA unit 19 may be incorporated into the same device as video encoder 20.

As shown in FIG. 8, RGB native CG video data 200 is input to DRA unit 19. In the context of video preprocessing by DRA unit 19, RGB native CG video data 200 is defined by an input color container. The input color container defines both a color gamut of video data 200 (e.g., BT. 709, BT. 2020, P3, etc.) and defines a color space of video data 200 (e.g., RGB, XYZ, YCrCb, YUV, etc.). In one example of the disclosure, DRA unit 19 may be configured to convert both the color gamut and the color space of RGB native CB video data 200 to a target color container for HDR′ data 216. Like the input color container, the target color container may define both color gamut and a color space. In one example of the disclosure, RGB native CB video data 200 may be HDR/WCG video, and may have a BT.2020 or P3 color gamut (or any WCG), and be in an RGB color space. In another example, RGB native CB video data 200 may be SDR video, and may have a BT.709 color gamut. In one example, the target color container for HDR′ data 216 may have been configured for HDR/WCG video (e.g., BT.2020 color gamut) and may use a color space more optimal for video encoding (e.g., YCrCb).

In one example of the disclosure, CG converter 202 may be configured to convert the color gamut of RGB native CG video data 200 from the color gamut of the input color container (e.g., first color container) to the color gamut of the target color container (e.g., second color container). As one example, CG converter 202 may convert RGB native CG video data 200 from a BT.709 color representation to a BT.2020 color representation, example of which is shown below.

The process to convert RGB BT.709 samples (R₇₀₉, G₇₀₉, B₇₀₉) to RGB BT.2020 samples (R₂₀₂₀, G₂₀₂₀, B₂₀₂₀) can be implemented with a two-step conversion that involves converting first to the XYZ representation, followed by a conversion from XYZ to RGB BT.2020 using the appropriate conversion matrices.

X=0.412391*R₇₀₉+0.357584*G₇₀₉+0.180481*B₇₀₉

Y=0.212639*R₇₀₉+0.715169*G₇₀₉+0.072192*B₇₀₉

Z=0.019331*R₇₀₉+0.119195*G₇₀₉+0.950532*B₇₀₉ (5)

Conversion from XYZ to R₂₀₂₀G₂₀₂₀B₂₀₂₀ (BT.2020)

R₂₀₂₀₌clipRGB(1.716651*X−0.355671*Y−0.253366*Z)

G₂₀₂₀₌clipRGB(−0.666684*X+1.616481*Y+0.015768*Z)

B₂₀₂₀=clipRGB(0.017640*X−0.042771*Y+0.942103*Z) (6)

Similarly, the single step and recommended method is as follows:

R₂₀₂₀=clipRGB(0.627404078626*R₇₀₉+0.329282097415*G₇₀₉+0.043313797587*B₇₀₉)

G2020=clipRGB(0.069097233123*R709+0.919541035593*G709+0.011361189924*B709) (7)

B₂₀₂₀₌clipRGB(0.016391587664*R₇₀₉+0.088013255546*G₇₀₉+0.895595009604*B₇₀₉)

The resulting video data after CG conversion is shown as RGB target CG video data 204 in FIG. 8. In other examples of the disclosure, the color gamut for the input color container and the output color container may be the same. In such an example, CG converter 202 need not perform any conversion on RGB native CG video data 200.

Next, transfer function unit 206 compacts the dynamic range of RGB target CG video data 204. Transfer function unit 206 may be configured to apply a transfer function to compact the dynamic range in the same manner as discussed above with reference to FIG. 4. The color conversion unit 208 converts RGB target CG color data 204 from the color space of the input color container (e.g., RGB) to the color space of the target color container (e.g., YCrCb). As explained above with reference to FIG. 4, color conversion unit 208 converts the compacted data into a more compact or robust color space (e.g., a YUV or YCrCb color space) that is more suitable for compression by a hybrid video encoder (e.g., video encoder 20).

Adjustment unit 210 is configured to perform a dynamic range adjustment (DRA) of the color converted video data in accordance with DRA parameters derived by DRA parameters estimation unit 212. In general, after CG conversion by CG converter 202 and dynamic range compaction by transfer function unit 206, the actual color values of the resulting video data may not use all available codewords (e.g., unique bit sequences that represent each color) allocated for the color gamut of a particular target color container. That is, in some circumstances, the conversion of RGB native CG video data 200 from an input color container to an output color container may overly compact the color values (e.g., Cr and Cb) of the video data such that the resultant compacted video data does not make efficient use of all possible color representations. As explained above, coding a signal with a reduced range of values for the colors may lead to a significant loss of accuracy for coded chroma components and would be observed by a viewer as coding artifacts, e.g., color mismatch and/or color bleeding.

Adjustment unit 210 may be configured to apply DRA parameters to the color components (e.g., YCrCb) of the video data, e.g., RGB target CG video data 204 after dynamic range compaction and color conversion to make full use of the codewords available for a particular target color container. Adjustment unit 210 may apply the DRA parameter to the video data at a pixel level. In general, the DRA parameters define a function that expands the codewords used to represent the actual video data to as many of the codewords available for the target color container as possible.

In one example of the disclosure, the DRA parameters include a scale and offset value that are applied to the components of the video data. In general, the lower the dynamic range of the values of the color components of the video data, the larger a scaling factor may be used. The offset parameter is used to center the values of the color components to the center of the available codewords for a target color container. For example, if a target color container includes 1024 codewords per color component, an offset value may be chosen such that the center codeword is moved to codeword 512 (e.g., the middle most codeword).

In one example, adjustment unit 210 applies DRA parameters to video data in the target color space (e.g., YCrCb) as follows:

Y″=scale1*Y′+offset1

Cb″=scale2*Cb′+offset2

Cr′=scale3

*Cr′+offset3 (8)

where signal components Y′, Cb′ and Cr′ is a signal produced from RGB to YCbCr conversion (example in equation 3). Note that Y′, Cr′ and Cr′ may also be a video signal decoded by video decoder 30. Y″, Cb″, and Cr″ are the color components of the video signal after the DRA parameters have been applied to each color component. As can be seen in the example above, each color component is related to different scale and offset parameters. For example, scale1 and offset 1 are used for the Y′ component, scale2 and offset2 are used for the Cb′ component, and scale3 and offset3 are used for the Cr′ component. It should be understood that this is just an example. In other examples, the same scale and offset values may be used for every color component.

In other examples, each color component may be associated with multiple scale and offset parameters. For example, the actual distribution of chroma values for the Cr or Cb color components may differ for different portions of codewords. As one example, there may be more unique codewords used above the center codeword (e.g., codeword 512) than there are below the center codeword. In such an example, adjustment unit 210 may be configured to apply one set of scale and offset parameters for chroma values above the center codeword (e.g., having values greater than the center codeword) and apply a different set of scale and offset parameters for chroma values below the center codeword (e.g., having values less than the center codeword).

As can be seen in the above example, adjustment unit 210 applies the scale and offset DRA parameters as a linear function. As such, it is not necessary for adjustment unit 210 to apply the DRA parameters in the target color space after color conversion by color conversion unit 208. This is because color conversion is itself a linear process. As such, in other examples, adjustment unit 210 may apply the DRA parameters to the video data in the native color space (e.g., RGB) before any color conversion process. In this example, color conversion unit 208 would apply color conversion after adjustment unit 210 applies the DRA parameters.

In another example of the disclosure, adjustment unit 210 may apply the DRA parameters in either the target color space or the native color space as follows:

Y″=(scale1*(Y′−offsetY)+offset1)+offsetY;

Cb″=scale2*Cb′+offset2

Cr″=scale3*Cr′+offset3

In this example, the parameter scale1, scale2, scale3, offset1, offset2, and offset3 have the same meaning as described above. The parameter offsetY is a parameter reflecting brightness of the signal, and can be equal to the mean value of Y′.

In another example of the disclosure, adjustment unit 210 may be configured to apply the DRA parameters in a color space other than the native color space or the target color space. In general, adjustment unit 210 may be configured to apply the DRA parameters as follows:

X′=scale1*X+offset1;

Y′=scale2*Y+offset2

Z′=scale3*Z+offset3 (10)

where signal components X, Y and Z are signal components in a color space which is different from target color space, e.g., RGB or an intermediate color space.

In other examples of the disclosure, adjustment unit 210 is configured to apply a linear transfer function to the video to perform DRA. Such a transfer function is different from the transfer function used by transfer function unit 206 to compact the dynamic range. Similar to the scale and offset terms defined above, the transfer function applied by adjustment unit 210 may be used to expand and center the color values to the available codewords in a target color container. An example of applying a transfer function to perform DRA is shown below:

Y″=TF2(Y′)

Cb″=TF2(Cb′)

Cr″=TF2(Cr′)

Term TF2 specifies the transfer function applied by adjustment unit 210.

In another example of the disclosure, adjustment unit 210 may be configured to apply the DRA parameters jointly with the color conversion of color conversion unit 208 in a single process. That is, the linear functions of adjustment unit 210 and color conversion unit 208 may be combined. An example of a combined application, where f1 and f2 are a combination of the RGB to YCbCr matrix and the DRA scaling factors, is shown below:

$$Cb = \frac{{B}^{′} - {Y}^{′}}{f 1} ;$$

$$Cr = \frac{{R}^{′} - {Y}^{′}}{f 2}$$

In another example of the disclosure, after applying the DRA parameters, adjustment unit 210 may be configured to perform a clipping process to prevent the video data from having values outside the range of codewords specified for a certain target color container. In some circumstances, the scale and offset parameters applied by adjustment unit 210 may cause some color component values to exceed the range of allowable codewords. In this case, adjustment unit 210 may be configured to clip the values of the components that exceed the range to the maximum value in the range.

The DRA parameters applied by adjustment unit 210 may be determined by DRA parameters estimation unit 212. How often DRA parameters estimation unit 212 updates the DRA parameters is flexible. For example, DRA parameters estimation unit 212 may update the DRA parameters on a temporal level. That is, new DRA parameters may be determined for a group of pictures (GOP), or a single picture (frame). In this example, the RGB native CG video data 200 may be a GOP or a single picture. In other examples, DRA parameters estimation unit 212 may update the DRA parameters on a spatial level, e.g., at the slice tile, or block level. In this context, a block of video data may be a macroblock, coding tree unit (CTU), coding unit, or any other size and shape of block. A block may be square, rectangular, or any other shape. Accordingly, the DRA parameters may be used for more efficient temporal and spatial prediction and coding.

In one example of the disclosure, DRA parameters estimation unit 212 may derive the DRA parameters based on the correspondence of the native color gamut of RGB native CG video data 200 and the color gamut of the target color container. For example, DRA parameters estimation unit 212 may use a set of predefined rules to determine scale and offset values given a certain native color gamut (e.g., BT.709) and the color gamut of a target color container (e.g., BT.2020).

For example, assume that native color gamut and target color container are defined in the form of color primaries coordinates in xy space and white point coordinates. One example of such information for BT.709 and BT.2020 is shown in Table 2 below.

TABLE 2
RGB color space parameters
RGB color space parameters

| | White point | | Primary colors | | | | | |
|---|---|---|---|---|---|---|---|---|
| Color space | x_{W} | y_{W} | x_{R} | y_{R} | x_{G} | y_{G} | x_{B} | y_{B} |
| DCI-P3 | .314 | .351 | .680 | .320 | .265 | .690 | .150 | .060 |
| ITU-R BT.709 | .3127 | .3290 | .64 | .33 | .30 | .60 | .15 | .06 |
| ITU-R | .3127 | .3290 | .708 | .292 | .170 | .797 | .131 | .046 |
| BT.2020 | | | | | | | | |

In one example, BT.2020 is the color gamut of the target color container and BT.709 is the color gamut of the native color container. In this example, adjustment unit 210 applies the DRA parameters to the YCbCr target color space. DRA parameters estimation unit 212 may be configured to estimate and forward the DRA parameters to adjustment unit 210 as follows:
scale1=1; offset1=0;
scale2=1.0698; offset2=0;
scale3=2.1735; offset3=0;

As another example, with BT.2020 being a target color gamut and P3 being a native color gamut, and DRA being applied in YCbCr target color space, DRA parameters estimation unit 212 may be configured to estimate the DRA parameters as:
scale1=1; offset1=0;
scale2=1.0068; offset2=0;
scale3=1.7913; offset3=0;

In the examples above, DRA parameters estimation unit 212 may be configured to determine the above-listed scale and offset values by consulting a lookup table that indicates the DRA parameters to use, given a certain native color gamut and a certain target color gamut. In other examples, DRA parameters estimation unit 212 may be configured to calculate the DRA parameters from the primary and white space values of the native color gamut and target color gamut, e.g., as shown in Table 2.

For example, consider a target (T) color container specified by primary coordinates (xXt, yXt), where X stated for R,G,B color components:

$$primeT = [ \begin{matrix}xRt & yRt \\ xGt & yGt \\ xBt & yBt\end{matrix} ]$$

and native (N) color gamut specified by primaries coordinates (xXn, yXn), where X stated for R,G,B color components:

$$primeN = [ \begin{matrix}xRn & yRn \\ xGn & yGn \\ xBn & yBn\end{matrix} ]$$

The white point coordinate for both gamuts equals whiteP=(xW,yW). DRA parameters estimation unit 212 may derive the scale2 and scale3 parameters for DRA as a function of the distances between primaries coordinates to the white point. One example of such an estimation is given below:

rdT=sqrt((primeT(1,1)−whiteP(1,1))̂2+(primeN(1,2)−whiteP(1,2))̂2)

gdT=sqrt((primeT(2,1)−whiteP(1,1))̂2+(primeN(2,2)−whiteP(1,2))̂2)

bdT=sqrt((primeT(3,1)−whiteP(1,1))̂2+(primeN(3,2)−whiteP(1,2))̂2)

rdN=sqrt((primeN(1,1)−whiteP(1,1))̂2+(primeN(1,2)−whiteP(1,2))̂2)

gdN=sqrt((primeN(2,1)−whiteP(1,1))̂2+(primeN(2,2)−whiteP(1,2))̂2)

bdN=sqrt((primeN(3,1)−whiteP(1,1))̂2+(primeN(3,2)−whiteP(1,2))̂2)

scale2=bdT/bdN

scale3=sqrt((rdT/rdN)̂2+(gdT/gdN)̂2)

In some examples, DRA parameters estimation unit 212 may be configured to estimate the DRA parameters by determining the primaries coordinates in primeN from the actual distribution of color values in RGB native CG video data 200, and not from the pre-defined primary values of the native color gamut. That is, DRA parameters estimation unit 212 may be configured to analyze the actual colors present in RGB native CG video data 200, and use the primary color values and white point determined from such an analysis in the function described above to calculate DRA parameters. Approximation of some parameters defined above might be used as DRA to facilitate the computation. For instance, scale3=2.1735 can be approximated to scale3=2, which allows for easier implementation in some architectures.

In other examples of the disclosure, DRA parameters estimation unit 212 may be configured to determine the DRA parameters based not only on the color gamut of the target color container, but also on the target color space. The actual distributions of values of component values may differ from color space to color space. For example, the chroma value distributions may be different for YCbCr color spaces having a constant luminance as compared to YCbCr color spaces having a non-constant luminance. DRA parameters estimation unit 212 may use the color distributions of different color spaces to determine the DRA parameters.

In other examples of the disclosure, DRA parameters estimation unit 212 may be configured to derive values for DRA parameters so as to minimize certain cost functions associated with pre-processing and/or encoding video data. As one example, DRA parameters estimation unit 212 may be configured to estimate DRA parameters that minimized quantization errors introduced by quantization unit 214 (e.g., see equation (4)) above. DRA parameters estimation unit 212 may minimize such an error by performing quantization error tests on video data that has had different sets of DRA parameters applied. DRA parameters estimation unit 212 may then select the DRA parameters that produced the lowest quantization error.

In another example, DRA parameters estimation unit 212 may select DRA parameters that minimize a cost function associated with both the DRA performed by adjustment unit 210 and the video encoding performed by video encoder 20. For example DRA parameters estimation unit 212 may perform DRA and encode the video data with multiple different sets of DRA parameters. DRA parameters estimation unit 212 may then calculate a cost function for each set of DRA parameters by forming a weighted sum of the bitrate resulting from DRA and video encoding, as well as the distortion introduced by these two lossy process. DRA parameters estimation unit 212 may then select the set of DRA parameters that minimizes the cost function.

In each of the above techniques for DRA parameter estimation, DRA parameters estimation unit 212 may determine the DRA parameters separately for each component using information regarding that component. In other examples, DRA parameters estimation unit 212 may determine the DRA parameters using cross-component information. For example, the DRA parameters derived for a Cr component may be used to derive DRA parameters for a CB component.

In addition to deriving DRA parameters, DRA parameters estimation unit 212 may be configured to signal the DRA parameters in an encoded bitstream. DRA parameters estimation unit 212 may signal one or more syntax elements that indicate the DRA parameters directly, or may be configured to provide the one or more syntax elements to video encoder 20 for signaling. Such syntax elements of the parameters may be signaled in the bitstream such that video decoder 30 and/or inverse DRA unit 31 may perform the inverse of the process of DRA unit 19 to reconstruct the video data in its native color container. Example techniques for signaling the DRA parameters are discussed below.

In one example, DRA parameters estimation unit 212 may signal one or more syntax elements that in an encoded video bitstream as metadata, in a supplemental enhancement information (SEI) message, in video usability information (VUI), in a video parameter set (VPS), in a sequence parameter set (SPS), in a picture parameter set, in a slice header, in a CTU header, or in any other syntax structure suitable for indicating the DRA parameters for the size of the video data (e.g., GOP, pictures, blocks, macroblock, CTUs, etc.).

In some examples, the one or more syntax elements indicate the DRA parameters explicitly. For example, the one or more syntax elements may be the various scale and offset values for DRA. In other examples, the one or more syntax elements may be one or more indices into a lookup table that includes the scale and offset values for DRA. In still another example, the one or more syntax elements may be indices into a lookup table that specifies the linear transfer function to use for DRA.

In other examples, the DRA parameters are not signaled explicitly, but rather, both DRA unit 19 and inverse DRA unit 31 are configured to derive the DRA parameters using the same pre-defined process using the same information and/or characteristics of the video data that are discernible form the bitstream. As one example, inverse DRA unit 31 may be configured to indicate the native color container of the video data as well as the target color container of the encoded video data in the encoded bitstream. Inverse DRA unit 31 may then be configured to derive the DRA parameters from such information using the same process as defined above. In some examples, one or more syntax elements that identify the native and target color containers are supplied in a syntax structure. Such syntax elements may indicate the color containers explicitly, or may be indices to a lookup table. In another example, DRA unit 19 may be configured to signal one or more syntax elements that indicate the XY values of the color primaries and the white point for a particular color container. In another example, DRA unit 19 may be configured to signal one or more syntax elements that indicate the XY values of the color primaries and the white point of the actual color values (content primaries and content white point) in the video data based on an analysis performed by DRA parameters estimation unit 212.

As one example, the color primaries of the smallest color gamut containing the color in the content might be signaled, and at video decoder 30 and/or inverse DRA unit 31, the DRA parameters are derived using both the container primaries and the content primaries. In one example, the content primaries can be signaled using the x and y components for R, G and B, as described above. In another example, the content primaries can be signaled as the ratio between two known primary sets. For example, the content primaries can be signaled as the linear position between the BT.709 primaries and the BT.2020 primaries: xᵣ_{_{content}}=alfaᵣxᵣ_{_}_{bt709}+(1−alfaᵣ)*xᵣ_{_}_{bt2020} (with similar equation with alfa_{g} and alfa_{b} for the G and B components), where parameter alfaᵣ specifies a ratio between two known primary sets. In some examples, the signaled and/or derived DRA parameters may be used by video encoder 20 and/or video decoder 30 to facilitate weighted prediction based techniques utilized for coding of HDR/WCG video data.

In video coding schemes utilizing weighted prediction, a sample of currently coded picture Sc are predicted from a sample (for single directional prediction) of the reference picture Sr taken with a weight (W_{wp}) and an offset (O_{wp}) which results in predicted sample Sp:

Sp=Sr·*W_{wp}+O_{wp}.

In some examples utilizing DRA, samples of the reference and currently coded picture can be processed with DRA employing different parameters, namely {scale1_{cur}, offset1_{cur}} for a current picture and {scale1_{ref}, offset1_{ref}} for a reference picture. In such embodiments, parameters of weighted prediction can be derived from DRA, e.g.:

W_{wp}=scale1_{cur}/scale1_{ref}

O_{wp}=offset1_{cur}−offset1_{ref}

After adjustment unit 210 applies the DRA parameters, DRA unit 19 may then quantize the video data using quantization unit 214. Quantization unit 214 may operate in the same manner as described above with reference to FIG. 4. After quantization, the video data is now adjusted in the target color space and target color gamut of the target color container of HDR′ data 316. HDR′ data 316 may then be sent to video encoder 20 for compression.

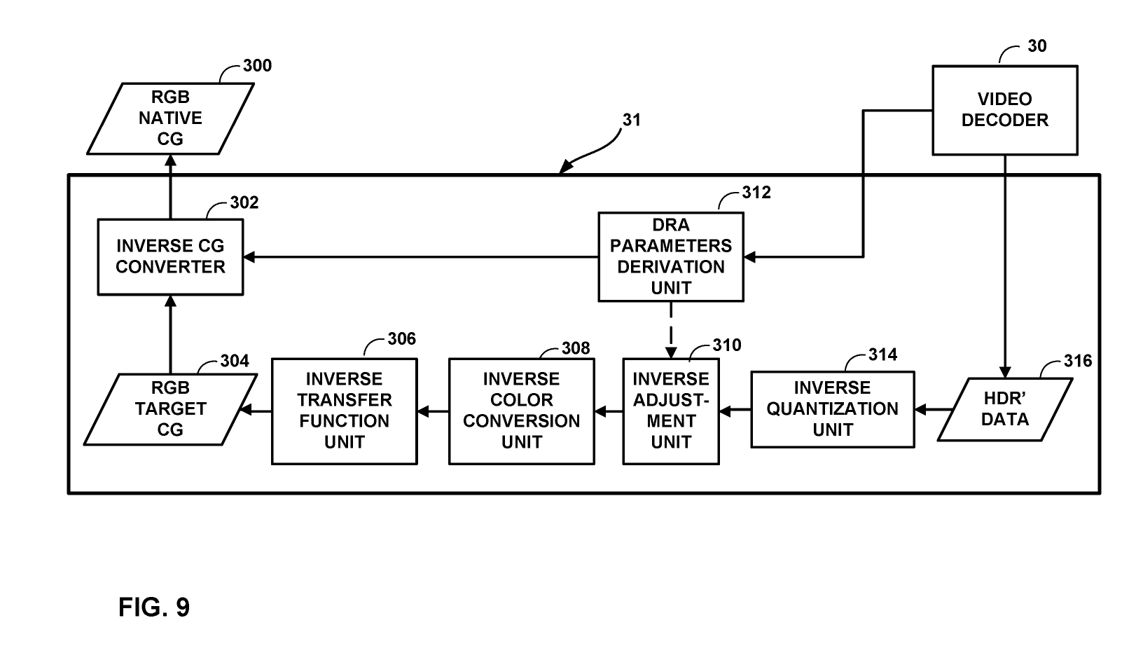

FIG. 9 is a block diagram illustrating an example HDR/WCG inverse conversion apparatus according to the techniques of this disclosure. As shown in FIG. 9, inverse DRA unit 31 may be configured to apply the inverse of the techniques performed by DRA unit 19 of FIG. 8. In other examples, the techniques of inverse DRA unit 31 may be incorporated in, and performed by, video decoder 30.

In one example, video decoder 30 may be configured to decode the video data encoded by video encoder 20. The decoded video data (HDR′ data 316 in the target color container) is then forwarded to inverse DRA unit 31. Inverse quantization unit 314 performs an inverse quantization process on HDR′ data 316 to reverse the quantization process performed by quantization unit 214 of FIG. 8.

Video decoder 30 may also be configured to decode and send any of the one or more syntax elements produced by DRA parameters estimation unit 212 of FIGS. 8 to DRA parameters derivation unit 312 of inverse DRA unit 13. DRA parameters derivation unit 312 may be configured to determine the DRA parameters based on the one or more syntax elements, as described above. In some examples, the one or more syntax elements indicate the DRA parameters explicitly. In other examples, DRA parameters derivation unit 312 is configured to derive the DRA parameters using the same techniques used by DRA parameters estimation unit 212 of FIG. 8.

The parameters derived by DRA parameters derivation unit 312 are sent to inverse adjustment unit 310. Inverse adjustment unit 310 uses the DRA parameters to perform the inverse of the linear DRA adjustment performed by adjustment unit 210. Inverse adjustment unit 310 may apply the inverse of any of the adjustment techniques described above for adjustment unit 210. In addition, as with adjustment unit 210, inverse adjustment unit 310 may apply the inverse DRA before or after any inverse color conversion. As such, inverse adjustment unit 310 may apply the DRA parameter on the video data in the target color container or the native color container.

Inverse color conversion unit 308 converts the video data from the target color space (e.g., YCbCr) to the native color space (e.g., RGB). Inverse transfer function 306 then applies an inverse of the transfer function applied by transfer function 206 to uncompact the dynamic range of the video data. The resulting video data (RGB target CG 304) is still in the target color gamut, but is now in the native dynamic range and native color space. Next, inverse CG converter 302 converts RGB target CG 304 to the native color gamut to reconstruct RGB native CG 300.

In some examples, additional post-processing techniques may be employed by inverse DRA unit 31. Applying the DRA may put the video outside its actual native color gamut. The quantization steps performed by quantization unit 214 and inverse quantization unit 314, as well as the up and down-sampling techniques performed by adjustment unit 210 and inverse adjustment unit 310, may contribute to the resultant color values in the native color container being outside the native color gamut. When the native color gamut is known (or the actual smallest content primaries, if signaled, as described above), then additional process can be applied to RGB native CG video data 304 to transform color values (e.g., RGB or Cb and Cr) back into the intended gamut as post-processing for DRA. In other examples, such post-processing may be applied after the quantization or after DRA application.

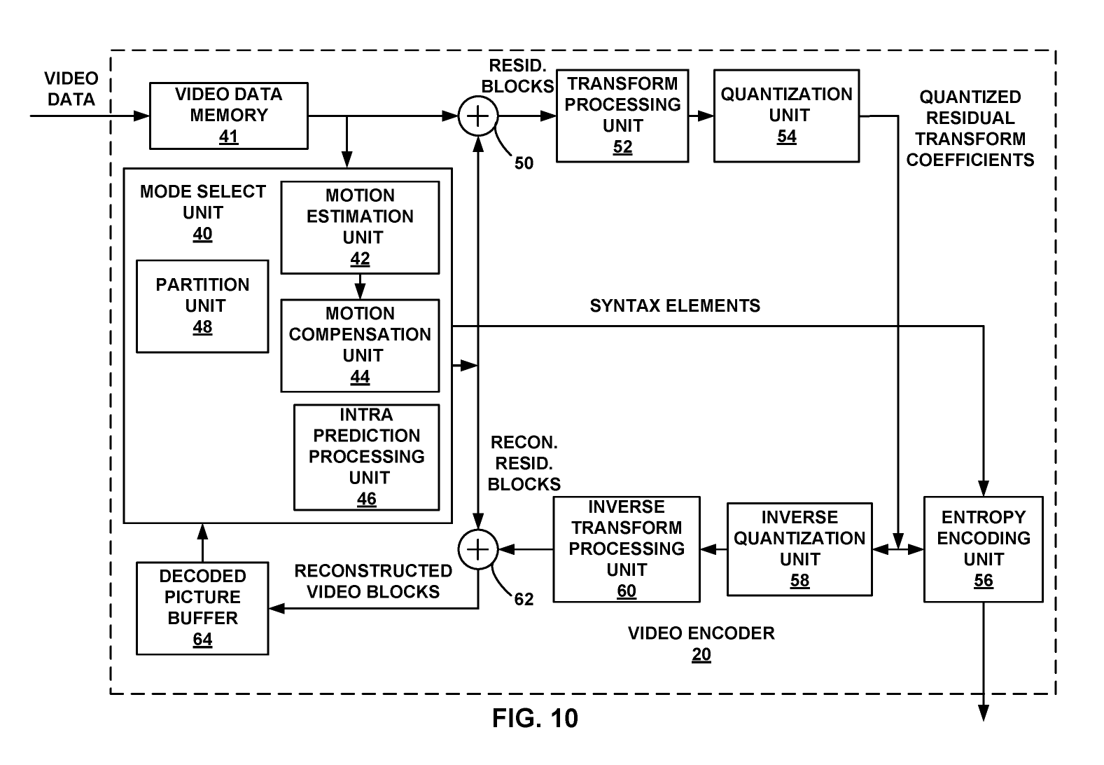

FIG. 10 is a block diagram illustrating an example of video encoder 20 that may implement the techniques of this disclosure. Video encoder 20 may perform intra- and inter-coding of video blocks within video slices in a target color container that have been processed by DRA unit 19. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 10, video encoder 20 receives a current video block within a video frame to be encoded. In the example of FIG. 10, video encoder 20 includes mode select unit 40, a video data memory 41, decoded picture buffer 64, summer 50, transform processing unit 52, quantization unit 54, and entropy encoding unit 56. Mode select unit 40, in turn, includes motion compensation unit 44, motion estimation unit 42, intra prediction processing unit 46, and partition unit 48. For video block reconstruction, video encoder 20 also includes inverse quantization unit 58, inverse transform processing unit 60, and summer 62. A deblocking filter (not shown in FIG. 10) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

Video data memory 41 may store video data to be encoded by the components of video encoder 20. The video data stored in video data memory 41 may be obtained, for example, from video source 18. Decoded picture buffer 64 may be a reference picture memory that stores reference video data for use in encoding video data by video encoder 20, e.g., in intra- or inter-coding modes. Video data memory 41 and decoded picture buffer 64 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 41 and decoded picture buffer 64 may be provided by the same memory device or separate memory devices. In various examples, video data memory 41 may be on-chip with other components of video encoder 20, or off-chip relative to those components.

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra prediction processing unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate- distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture (or other coded unit) relative to the current block being coded within the current picture (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in decoded picture buffer 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in decoded picture buffer 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra prediction processing unit 46 may intra-predict a current block, as an alternative to the inter-prediction performed by motion estimation unit 42 and motion compensation unit 44, as described above. In particular, intra prediction processing unit 46 may determine an intra-prediction mode to use to encode a current block. In some examples, intra prediction processing unit 46 may encode a current block using various intra-prediction modes, e.g., during separate encoding passes, and intra prediction processing unit 46 (or mode select unit 40, in some examples) may select an appropriate intra-prediction mode to use from the tested modes.

For example, intra prediction processing unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bit rate (that is, a number of bits) used to produce the encoded block. Intra prediction processing unit 46 may calculate ratios from the distortions and rates for the various encoded blocks to determine which intra- prediction mode exhibits the best rate-distortion value for the block.

After selecting an intra-prediction mode for a block, intra prediction processing unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain. Transform processing unit 52 may send the resulting transform coefficients to quantization unit 54.

Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform processing unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of decoded picture buffer 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in decoded picture buffer 64. The reconstructed video block may be used by motion estimation unit 42 and motion compensation unit 44 as a reference block to inter-code a block in a subsequent video frame.

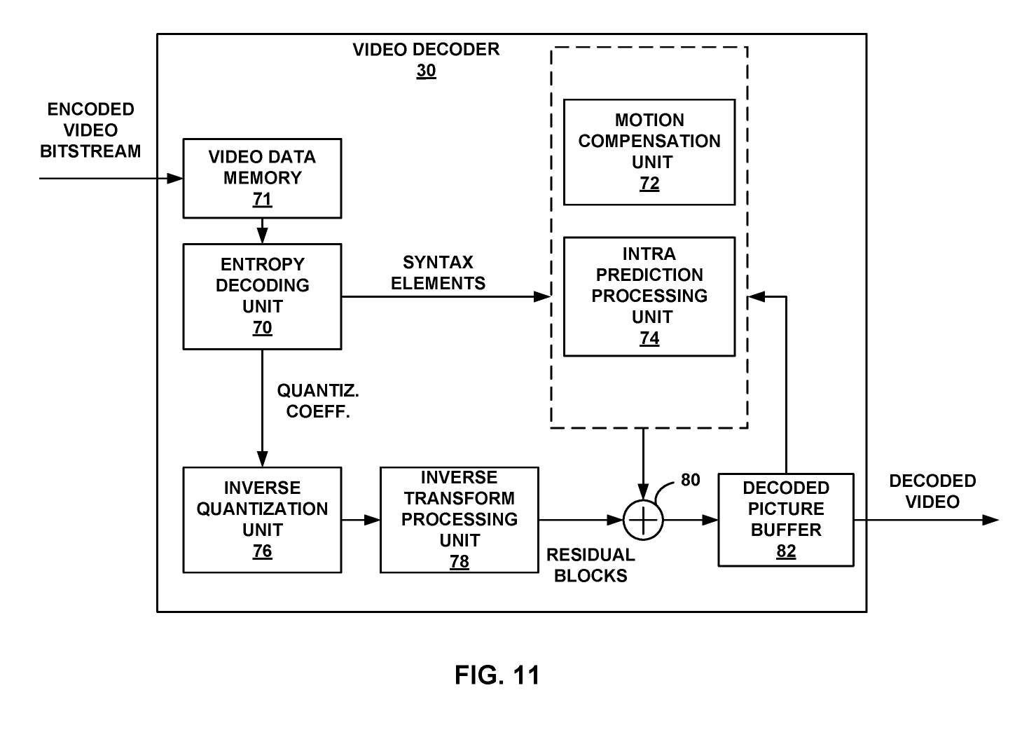

FIG. 11 is a block diagram illustrating an example of video decoder 30 that may implement the techniques of this disclosure. In particular, video decoder 30 may decode video data into a target color container that may then be processed by inverse DRA unit 31, as described above. In the example of FIG. 11, video decoder 30 includes an entropy decoding unit 70, a video data memory 71, motion compensation unit 72, intra prediction processing unit 74, inverse quantization unit 76, inverse transform processing unit 78, decoded picture buffer 82 and summer 80. Video decoder 30 may, in some examples, perform a decoding pass generally reciprocal to the encoding pass described with respect to video encoder 20 (FIG. 10). Motion compensation unit 72 may generate prediction data based on motion vectors received from entropy decoding unit 70, while intra prediction processing unit 74 may generate prediction data based on intra- prediction mode indicators received from entropy decoding unit 70.

Video data memory 71 may store video data, such as an encoded video bitstream, to be decoded by the components of video decoder 30. The video data stored in video data memory 71 may be obtained, for example, from computer-readable medium 16, e.g., from a local video source, such as a camera, via wired or wireless network communication of video data, or by accessing physical data storage media. Video data memory 71 may form a coded picture buffer (CPB) that stores encoded video data from an encoded video bitstream. Decoded picture buffer 82 may be a reference picture memory that stores reference video data for use in decoding video data by video decoder 30, e.g., in intra- or inter-coding modes. Video data memory 71 and decoded picture buffer 82 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 71 and decoded picture buffer 82 may be provided by the same memory device or separate memory devices. In various examples, video data memory 71 may be on-chip with other components of video decoder 30, or off-chip relative to those components.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction processing unit 74 may generate prediction data for a video block of the current video slice based on a signaled intra prediction mode and data from previously decoded blocks of the current frame or picture. When the video frame is coded as an inter-coded (i.e., B or P) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference picture lists, List 0 and List 1, using default construction techniques based on reference pictures stored in decoded picture buffer 82. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied. Inverse transform processing unit 78 applies an inverse transform, e.g., an inverse DCT, an inverse integer transform, or a conceptually similar inverse transform process, to the transform coefficients in order to produce residual blocks in the pixel domain.

After motion compensation unit 72 generates the predictive block for the current video block based on the motion vectors and other syntax elements, video decoder 30 forms a decoded video block by summing the residual blocks from inverse transform processing unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in decoded picture buffer 82, which stores reference pictures used for subsequent motion compensation. Decoded picture buffer 82 also stores decoded video for later presentation on a display device, such as display device 32 of FIG. 1.

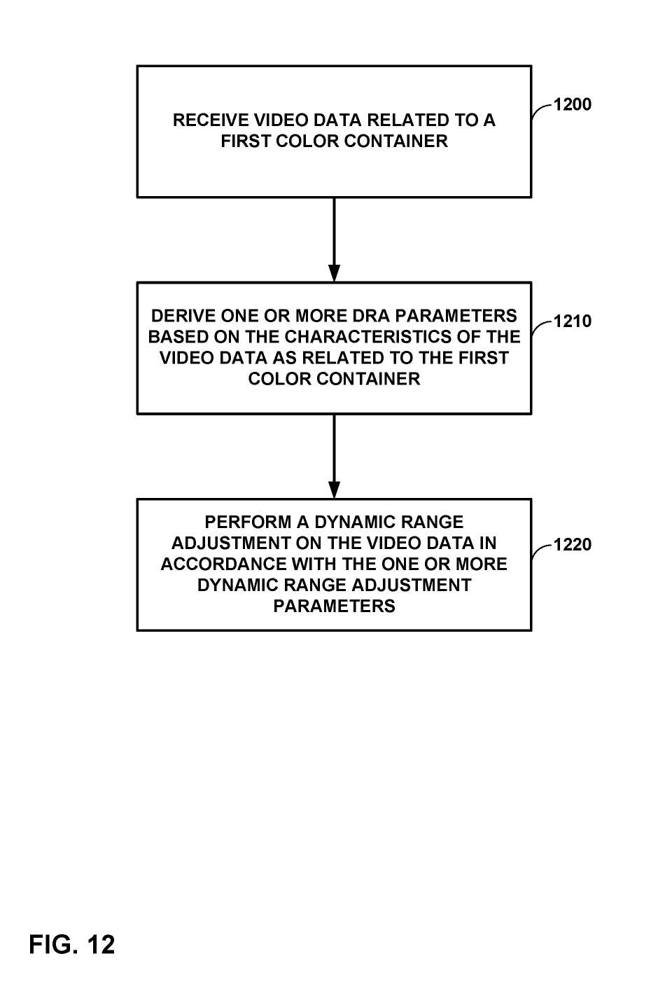

FIG. 12 is a flowchart illustrating an example HDR/WCG conversion process according to the techniques of this disclosure. The techniques of FIG. 12 may be executed by source device 12 of FIG. 1, including one or more of DRA unit 19 and/or video encoder 20.

In one example of the disclosure, source device 12 may be configured to receive video data related to a first color container, the video data related to the first color container being defined by a first color gamut and a first color space (1200), derive one or more dynamic range adjustment parameters, the dynamic range adjustment parameters being based on characteristics of the video data as related to the first color container (1210), and perform a dynamic range adjustment on the video data in accordance with the one or more dynamic range adjustment parameters (1220). In the example of FIG. 12, the video data is input video data prior to video encoding, wherein the first color container is a native color container, and wherein the second color container is a target color container. In one example, the video data is one of a group of pictures of video data, a picture of video data, a macroblock of video data, a block of video data, or a coding unit of video data.

In one example of the disclosure, the characteristics of the video data include the first color gamut. In one example, source device 12 is configured to derive the one or more dynamic range adjustment parameters based on a correspondence of the first color gamut of the first color container and a second color gamut of a second color container, the second color container being defined by the second color gamut and a second color space.

In another example of the disclosure, source device 12 is configured to signal one or more syntax elements indicating the first color gamut and the second color container in an encoded video bitstream in one or more of metadata, a supplemental enhancement information message, video usability information, a video parameter set, a sequence parameter set, a picture parameter, a slice header, or a CTU header.

In another example of the disclosure, source device 12 is configured to signal one or more syntax elements explicitly indicating the dynamic range adjustment parameters in an encoded video bitstream in one or more of metadata, a supplemental enhancement information message, video usability information, a video parameter set, a sequence parameter set, a picture parameter, a slice header, or a CTU header.

In another example of the disclosure, the characteristics of the video data include brightness information, and source device 12 is configured to derive the one or more dynamic range adjustment parameters based on the brightness information of the video data. In another example of the disclosure, the characteristics of the video data include color values, and source device 12 is configured to derive the one or more dynamic range adjustment parameters based on the color values of the video data.

In another example of the disclosure, source device 12 is configured to derive the one or more dynamic range adjustment parameters by minimizing one of a quantization error associated with quantizing the video data, or a cost function associated with encoding the video data.

In another example of the disclosure, the one or more dynamic range adjustment parameters include a scale and an offset for each color component of the video data, and source device 12 is further configured to adjust each color component of the video data according to a function of the scale and the offset for each respective color component.

In another example of the disclosure, the one or more dynamic range parameters include a first transfer function, and source device 12 is further configured to apply the first transfer function to the video data.

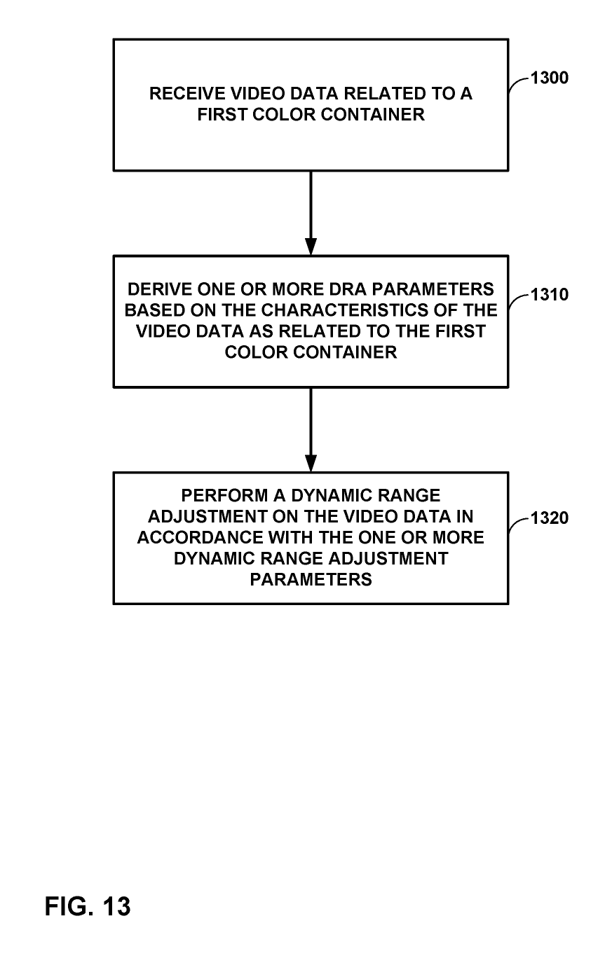

FIG. 13 is a flowchart illustrating an example HDR/WCG inverse conversion process according to the techniques of this disclosure. The techniques of FIG. 13 may be executed by destination device 14 of FIG. 1, including one or more of inverse DRA unit 31 and/or video decoder 30.

In one example of the disclosure, destination device 14 may be configured to receive video data related to a first color container, the video data related to the first color container being defined by a first color gamut and a first color space (1300), derive one or more dynamic range adjustment parameters, the dynamic range adjustment parameters being based on characteristics of the video data as related to the first color container (1310), and perform a dynamic range adjustment on the video data in accordance with the one or more dynamic range adjustment parameters (1320). In the example of FIG. 13, the video data is decoded video data, wherein the first color container is a target color container, and wherein the second color container is a native color container. In one example, the video data is one of a group of pictures of video data, a picture of video data, a macroblock of video data, a block of video data, or a coding unit of video data.

In one example of the disclosure, the characteristics of the video data include the first color gamut, and destination device 14 may be configured to derive the one or more dynamic range adjustment parameters based on a correspondence of the first color gamut of the first color container and a second color gamut of a second color container, the second color container being defined by the second color gamut and a second color space.

In another example of the disclosure, destination device 14 may be configured to receive one or more syntax elements indicating the first color gamut and the second color container, and derive the one or more dynamic range adjustment parameters based on the received one or more syntax elements. In another example of the disclosure, destination device 14 may be configured to derive parameters of weighted prediction from the one or more dynamic range adjustment parameters for a currently coded picture and a reference picture. In another example of the disclosure, destination device 14 may be configured to receive one or more syntax elements explicitly indicating the dynamic range adjustment parameters.

In another example of the disclosure, the characteristics of the video data include brightness information, and destination device 14 is configured to derive the one or more dynamic range adjustment parameters based on the brightness information of the video data. In another example of the disclosure, the characteristics of the video data include color values, and destination device 14 is configured to derive the one or more dynamic range adjustment parameters based on the color values of the video data.

In another example of the disclosure, the one or more dynamic range adjustment parameters include a scale and an offset for each color component of the video data, and destination device 14 is further configured to adjust each color component of the video data according to a function of the scale and the offset for each respective color component.

In another example of the disclosure, the one or more dynamic range parameters include a first transfer function, destination device 14 is further configured to apply the first transfer function to the video data.

Certain aspects of this disclosure have been described with respect to extensions of the HEVC standard for purposes of illustration. However, the techniques described in this disclosure may be useful for other video coding processes, including other standard or proprietary video coding processes not yet developed.

A video coder, as described in this disclosure, may refer to a video encoder or a video decoder. Similarly, a video coding unit may refer to a video encoder or a video decoder. Likewise, video coding may refer to video encoding or video decoding, as applicable.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
receiving video data related to a first color container, the video data related to the first color container being defined by a first color gamut and a first color space;
deriving one or more dynamic range adjustment parameters, the dynamic range adjustment parameters being based on characteristics of the video data as related to the first color container; and
performing a dynamic range adjustment on the video data in accordance with the one or more dynamic range adjustment parameters.

2. The method of claim 1, wherein the characteristics of the video data include the first color gamut, the method further comprising:
deriving the one or more dynamic range adjustment parameters based on a correspondence of the first color gamut of the first color container and a second color gamut of a second color container, the second color container being defined by the second color gamut and a second color space.

3. The method of claim 2, wherein the video data is input video data prior to video encoding, wherein the first color container is a native color container, and wherein the second color container is a target color container.

4. The method of claim 3, further comprising:
signaling one or more syntax elements indicating the first color gamut and the second color container in an encoded video bitstream in one or more of metadata, a supplemental enhancement information message, video usability information, a video parameter set, a sequence parameter set, a picture parameter, a slice header, or a CTU header.

5. The method of claim 2, wherein the video data is decoded video data, wherein the first color container is a target color container, and wherein the second color container is a native color container.

6. The method of claim 5, further comprising:
receiving one or more syntax elements indicating the first color gamut and the second color container; and
deriving the one or more dynamic range adjustment parameters based on the received one or more syntax elements.

7. The method of claim 6, further comprising:
deriving parameters of weighted prediction from the one or more dynamic range adjustment parameters for a currently coded picture and a reference picture.

8. The method of claim 2, further comprising:
signaling one or more syntax elements explicitly indicating the dynamic range adjustment parameters in an encoded video bitstream in one or more of metadata, a supplemental enhancement information message, video usability information, a video parameter set, a sequence parameter set, a picture parameter, a slice header, or a CTU header.

9. The method of claim 2, wherein deriving the one or more dynamic range adjustment parameters comprises:
receiving one or more syntax elements explicitly indicating the dynamic range adjustment parameters.

10. The method of claim 1, wherein the characteristics of the video data include brightness information, the method further comprising:
deriving the one or more dynamic range adjustment parameters based on the brightness information of the video data.

11. The method of claim 1, wherein the characteristics of the video data include color values, the method further comprising:
deriving the one or more dynamic range adjustment parameters based on the color values of the video data.

12. The method of claim 1, further comprising:
deriving the one or more dynamic range adjustment parameters by minimizing one of a quantization error associated with quantizing the video data, or a cost function associated with encoding the video data.

13. The method of claim 1, wherein the one or more dynamic range adjustment parameters include a scale and an offset for each color component of the video data, the method further comprising:
adjusting each color component of the video data according to a function of the scale and the offset for each respective color component.

14. The method of claim 1, wherein the one or more dynamic range parameters include a first transfer function, the method further comprising:
applying the first transfer function to the video data.

15. The method of claim 1, wherein the video data is one of a group of pictures of video data, a picture of video data, a macroblock of video data, a block of video data, or a coding unit of video data.

16. An apparatus configured to process video data, the apparatus comprising:
a memory configured to store the video data; and
one or more processors configured to:
receive the video data related to a first color container, the video data related to the first color container being defined by a first color gamut and a first color space;
derive one or more dynamic range adjustment parameters, the dynamic range adjustment parameters being based on characteristics of the video data as related to the first color container; and
perform a dynamic range adjustment on the video data in accordance with the one or more dynamic range adjustment parameters.

17. The apparatus of claim 16, wherein the characteristics of the video data include the first color gamut, and wherein the one or more processors are further configured to:
derive the one or more dynamic range adjustment parameters based on a correspondence of the first color gamut of the first color container and a second color gamut of a second color container, the second color container being defined by the second color gamut and a second color space.

18. The apparatus of claim 17, wherein the video data is input video data prior to video encoding, wherein the first color container is a native color container, and wherein the second color container is a target color container.

19. The apparatus of claim 18, wherein the one or more processors are further configured to:
signal one or more syntax elements indicating the first color gamut and the second color container in an encoded video bitstream in one or more of metadata, a supplemental enhancement information message, video usability information, a video parameter set, a sequence parameter set, a picture parameter, a slice header, or a CTU header.

20. The apparatus of claim 17, wherein the video data is decoded video data, wherein the first color container is a target color container, and wherein the second color container is a native color container.

21. The apparatus of claim 20, wherein the one or more processors are further configured to:
receive one or more syntax elements indicating the first color gamut and the second color container; and
derive the one or more dynamic range adjustment parameters based on the received one or more syntax elements.

22. The apparatus of claim 21, wherein the one or more processors are further configured to:
derive parameters of weighted prediction from the one or more dynamic range adjustment parameters for a currently coded picture and a reference picture.

23. The apparatus of claim 17, wherein the one or more processors are further configured to:
signal one or more syntax elements explicitly indicating the dynamic range adjustment parameters in an encoded video bitstream in one or more of metadata, a supplemental enhancement information message, video usability information, a video parameter set, a sequence parameter set, a picture parameter, a slice header, or a CTU header.

24. The apparatus of claim 17, wherein the one or more processors are further configured to:
receive one or more syntax elements explicitly indicating the dynamic range adjustment parameters.

25. The apparatus of claim 16, wherein the characteristics of the video data include brightness information, and wherein the one or more processors are further configured to:
derive the one or more dynamic range adjustment parameters based on the brightness information of the video data.

26. The apparatus of claim 16, wherein the characteristics of the video data include color values, and wherein the one or more processors are further configured to:
derive the one or more dynamic range adjustment parameters based on the color values of the video data.

27. The apparatus of claim 16, wherein the one or more processors are further configured to:
derive the one or more dynamic range adjustment parameters by minimizing one of a quantization error associated with quantizing the video data, or a cost function associated with encoding the video data.

28. The apparatus of claim 16, wherein the one or more dynamic range adjustment parameters include a scale and an offset for each color component of the video data, and wherein the one or more processors are further configured to:
adjust each color component of the video data according to a function of the scale and the offset for each respective color component.

29. The apparatus of claim 16, wherein the one or more dynamic range parameters include a first transfer function, and wherein the one or more processors are further configured to:
apply the first transfer function to the video data.

30. The apparatus of claim 16, wherein the video data is one of a group of pictures of video data, a picture of video data, a macroblock of video data, a block of video data, or a coding unit of video data.

31. An apparatus configured to process video data, the apparatus comprising:
means for receiving video data related to a first color container, the video data related to the first color container being defined by a first color gamut and a first color space;
means for deriving one or more dynamic range adjustment parameters, the dynamic range adjustment parameters being based on characteristics of the video data as related to the first color container; and
means for performing a dynamic range adjustment on the video data in accordance with the one or more dynamic range adjustment parameters.

32. The apparatus of claim 31, wherein the characteristics of the video data include the first color gamut, the apparatus further comprising:
means for deriving the one or more dynamic range adjustment parameters based on a correspondence of the first color gamut of the first color container and a second color gamut of a second color container, the second color container being defined by the second color gamut and a second color space.

33. The apparatus of claim 32, wherein the video data is input video data prior to video encoding, wherein the first color container is a native color container, and wherein the second color container is a target color container.

34. The apparatus of claim 33, further comprising:
means for signaling one or more syntax elements indicating the first color gamut and the second color container in an encoded video bitstream in one or more of metadata, a supplemental enhancement information message, video usability information, a video parameter set, a sequence parameter set, a picture parameter, a slice header, or a CTU header.

35. The apparatus of claim 32, wherein the video data is decoded video data, wherein the first color container is a target color container, and wherein the second color container is a native color container.

36. The apparatus of claim 35, further comprising:
means for receiving one or more syntax elements indicating the first color gamut and the second color container; and
means for deriving the one or more dynamic range adjustment parameters based on the received one or more syntax elements.

37. The apparatus of claim 36, further comprising:
means for deriving parameters of weighted prediction from the one or more dynamic range adjustment parameters for a currently coded picture and a reference picture.

38. The apparatus of claim 32, further comprising:
means for signaling one or more syntax elements explicitly indicating the dynamic range adjustment parameters in an encoded video bitstream in one or more of metadata, a supplemental enhancement information message, video usability information, a video parameter set, a sequence parameter set, a picture parameter, a slice header, or a CTU header.

39. The apparatus of claim 32, wherein the means for deriving the one or more dynamic range adjustment parameters comprises:
means for receiving one or more syntax elements explicitly indicating the dynamic range adjustment parameters.

40. The apparatus of claim 31, wherein the characteristics of the video data include brightness information, the apparatus further comprising:
means for deriving the one or more dynamic range adjustment parameters based on the brightness information of the video data.

41. The apparatus of claim 31, wherein the characteristics of the video data include color values, the apparatus further comprising:
means for deriving the one or more dynamic range adjustment parameters based on the color values of the video data.

42. The apparatus of claim 31, further comprising:
means for deriving the one or more dynamic range adjustment parameters by minimizing one of a quantization error associated with quantizing the video data, or a cost function associated with encoding the video data.

43. The apparatus of claim 31, wherein the one or more dynamic range adjustment parameters include a scale and an offset for each color component of the video data, the apparatus further comprising:
means for adjusting each color component of the video data according to a function of the scale and the offset for each respective color component.

44. The apparatus of claim 31, wherein the one or more dynamic range parameters include a first transfer function, the apparatus further comprising:
means for applying the first transfer function to the video data.

45. The apparatus of claim 31, wherein the video data is one of a group of pictures of video data, a picture of video data, a macroblock of video data, a block of video data, or a coding unit of video data.

46. A computer-readable storage medium storing instructions that, when executed, cause one on more processors to:
receive the video data related to a first color container, the video data related to the first color container being defined by a first color gamut and a first color space;
derive one or more dynamic range adjustment parameters, the dynamic range adjustment parameters being based on characteristics of the video data as related to the first color container; and
perform a dynamic range adjustment on the video data in accordance with the one or more dynamic range adjustment parameters.
